(19) United States
(12) Patent Application Publication
(10) Pub. No.: US 2007/0157263 A1
(43) Pub. Date: Jul. 5, 2007

(54) CONTENT MANAGEMENT SYSTEM

(75) Inventors: Yuki Horii, Osaka (JP); Shigeaki Watanabe, Osaka, NJ (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/612,607

(22) Filed: Dec. 19, 2006

Related U.S. Application Data
(60) Provisional application No. 60/751,314, filed on Dec. 19, 2005.

(51) Int. Cl. H04N 7/173; H04N 7/16

(52) U.S. Cl. 725/87; 725/134; 725/142; 725/86

(57) ABSTRACT

A content management system which increases the degree of freedom with which a broadcast station can manage content. In the content management system, a client terminal apparatus includes: a terminal ID acquisition unit which holds a terminal ID for identifying that client terminal apparatus; a copy allowance inquiry unit which inquires, with a broadcast station system, whether or not transferring recorded content stored in a secondary storage unit of a server terminal apparatus is allowed; and a copy processing unit which makes a request to the server terminal apparatus to transfer the recorded content in the case where the broadcast station system has allowed the transfer, and records the transferred recorded content into a storage medium.

### CROSS REFERENCE TO RELATED APPLICATION

This application claims the benefit of U.S. Provisional Application No. 60/751,314, filed Dec. 19, 2005, the contents of which are herein incorporated by reference in its entirety.

### BACKGROUND OF THE INVENTION

(1) Field of the Invention

The present invention relates to a content management system which includes a recording and reproduction apparatus that accumulates a content and reproduces the accumulated content. In particular, the present invention relates to a system which allows copying and reproduction of the accumulated content while restricting the copying and reproduction to a certain fluctuating set of recording and reproduction apparatuses.

(2) Description of the Related Art

Various content is included in a broadcast signal sent from a broadcast station. Aside from video and audio used in a normal TV program, there are cases where data is included in the content. There are several methods for sending the data, which can be roughly divided into a method of sending the data chronologically and a method of repeatedly sending the data per set interval. In the former method of sending the data chronologically, for example, data that continues over the course of time is sent in sequential order. This method is suitable for sending large amounts of data over a long period of time, but there is a drawback in that data that could not be received due to timing of the send cannot be received again. On the other hand, in the latter method of repeatedly sending the data at a set interval, the same data is repeatedly sent any number of times during a fixed period. This method has an advantage in that during the period when the same data is being sent, any one of the repeatedly-sent pieces of data can be received, and thus the timing of receiving is not restricted. Data broadcast, represented by BML, and file sending through DSM-CC data carousel are examples of this method. It is unknown, particularly in broadcast, when a recipient will select a channel and commence reception. In the method of sending the data chronologically, when the reception is commenced after the send has been performed and acquisition of the data fails as a result, the data cannot be re-acquired. Therefore, when sending data such as an application program along with video and audio in the broadcast signal, the method of repeatedly sending the data per set interval is favorable.

At present, specifications for receiving a broadcast signal that includes video, audio, and an application program and executing the application program in synchronization with video and audio, as in the above method, have been developed and are in operation. It is possible to receive the sent application program, import the application program into a terminal, and implement various extra functions by executing the application program, rather than simply viewing the video and audio. This method for sending the application program and importing the application program into the terminal is also called “downloading”. For example, a specification called Digital Video Broadcasting-Multimedia Home Platform (DVB-MHP) ETSIES201812 v11.1. (2003-12) has been developed in Europe, and operations according to this specification have already commenced. In addition, Open Cable Application Platform (OCAP), which provides the same specification in the cable broadcast environment in the United States, is being developed in the United States, and actual operations are set to commence. In these specifications, the application program is written in the Java language. Various Application Programming Interfaces (APIs) for tuning, graphics display, and the like are provided in the terminal, and the Java application program can control those functions by calling the APIs.

In addition, in North America, the OCAP-DVROC-SP-OCAP-DVR-I01-040524 specification, which is aimed at adding a function for recording and reproducing the content in the OCAP specification, is being developed. With this specification, the video, audio, and the Java application program synchronized thereto and executed, which are sent as a cable television broadcast, are recorded as the content, and furthermore, are reproduced in the same manner as when the recorded content is directly reproduced from the broadcast signal. The application program is reproduced in synchronization with the video and audio, in the same manner as direct reproduction from the broadcast signal.

In addition, in OCAP-DVR, the copying of recorded content to a hard disk, solid-state memory, or the like, as well as the terminals that can reproduce the recorded content, are restricted to the terminal which recorded the content.

However, there is a trend in North America toward the development of a home networking extension standard for OCAP-DVR (OCAP Home Networking Extension OC-SP-OCAP-HNEXT 1.0-101-050519). With this extension, the sharing of content recorded in accordance with the OCAP-DVR standard between terminals and the reproduction of the shared content are under development.

Technology which controls the copying and reproduction of content in terminals that reproduce recorded content that is shared between terminals has been disclosed in, for example, Patent Reference 1 (Japanese Laid-Open Patent Application No. 2002-10189). The technology disclosed in Patent Reference 1 implements copy control and reproduction control of content by overlaying a copy control flag or a reproduction control flag on the content itself.

As described above, in the OCAP-DVR standard, the copying of recorded content to a hard disk, solid-state memory, or the like, as well as the terminals that can reproduce the recorded content, are restricted to the terminal which recorded the content.

Meanwhile, in the OCAP-HN standard, there is a trend towards sharing recorded content between terminals and reproducing the shared content.

However, as a future trend, a system which allows copying and reproduction of recorded content only in certain limited devices can be considered necessary to prevent indiscriminate copying of the content. Specifically, “certain limited devices” can be thought of as referring to devices which a user who subscribes to a cable television service owns and for which the copying and reproduction of content is approved by the broadcast station. Here, it can be thought that the user interface should be improved and processing on the user's side, such as the use of a medium such as a CableCard or the input of a password, eliminated. Furthermore, the device owned by the user is not fixed, but rather changes when the user purchases a new device; thus it can be thought that copying and reproduction of content limited to a device owned by the user and for which copying and reproduction is approved by the broadcast station, for situations in which the user has changed the device he/she owns after repeatedly copying content, needs to be implemented.

For example, there are cases where the device which the user owns and which is approved by the broadcast station is changed when content is received from the broadcast station and when content is copied. Implementing of copying/reproduction of content limited to a device which is the newest device at the time of copying and for which copying is approved by the broadcast station can be considered necessary in such cases.

In such a manner, a conventional content management apparatus which includes a broadcast station and several terminals restricts the copying and reproduction of content by having the user perform operations or by overlaying a copy control flag or a reproduction control flag onto the content itself.

However, the abovementioned conventional content management apparatus has a problem in that operations on the part of the user are troublesome and also in that the broadcast station cannot freely restrict copying.

In other words, with the conventional method that requires processing on the part of the user, it is not possible to improve the user interface in the manner described earlier. In addition, with the method of applying copy restriction to the content itself, it is not possible to control copy allowance from the broadcast station, and the method furthermore cannot respond to the device being changed.

Accordingly, a goal of the present invention, which has been conceived in light of the aforementioned problems, is to provide a content management system in which the user interface is improved and the degree of freedom with which a broadcast station can manage the content is increased.

### SUMMARY OF THE INVENTION

In order to achieve the abovementioned goal, the content management system of the present invention includes a server terminal apparatus that holds, as recorded content, content broadcasted from a broadcast station apparatus, and a client terminal apparatus that requests the recorded content from the server terminal apparatus. The server terminal apparatus includes a content storage unit which stores content broadcasted over a channel in association with an identifier of the channel as the recorded content, and a first processing unit which receives a request to transfer the recorded content stored in said content storage unit, and transfers the recorded content. The client terminal apparatus includes: a terminal information holding unit which holds terminal identification information for identifying the client terminal apparatus; an inquiry unit which inquires with the broadcast station apparatus as to whether or not transfer of the recorded content stored in the content storage unit of the server terminal apparatus is permitted; and a second processing unit which requests the server terminal apparatus to transfer the recorded content in the case where the transfer is permitted by the broadcast station apparatus, and stores the transferred recorded content in a storage medium.

Through this, when the client terminal apparatus acquires recorded content from the server terminal apparatus, permission of the part of the broadcast station apparatus is required; therefore, it is possible to increase the degree of freedom with which the broadcast station apparatus manages the content. Moreover, no operation on the part of the user is necessary, which makes it possible to improve the user interface. In other words, it becomes possible for the broadcast station apparatus to restrict the use of recorded content stored in the server terminal apparatus.

In addition, the content management system may further include the broadcast station apparatus, which includes: a table holding unit which holds a terminal group management table that includes a terminal identification list for identifying a terminal for which the transfer is permitted, a channel identifier list including channel identifiers of channels viewable via a terminal associated with terminal identification information present in the terminal identification list, and terminal group identification information which identifies the terminal identification list and the channel identifier list; and a permission issuing unit which issues permission for the transfer in response to the request from the client terminal apparatus. The inquiry unit of the client terminal apparatus may send the channel identifier of the recorded content and the terminal identification information to the broadcast station apparatus along with performing the inquiry, and the permission issuing unit may refer to the terminal group management table held by said table holding unit, and issue permission for the transfer to said client terminal apparatus in the case where the terminal identification list, which includes the terminal identification information, and the channel identifier list, which includes the channel identifier, are specified by the same terminal group identification information.

Through this, it is possible for the broadcast station system to appropriately issue permission for transfers based on a terminal group management table.

In addition, the broadcast station apparatus may further hold group lock locking information which is associated with the terminal group identification information; the client terminal apparatus may further include a group lock locking unit which acquires, from the broadcast station apparatus, the group lock locking information corresponding to the terminal group identification information that identifies the terminal identification list including the terminal identification information held by the client terminal apparatus, holds the group lock locking information, and sets a restriction on copying of the recorded content using the held group lock locking information; and the group lock locking unit may set the restriction on copying of the recorded content using the group lock locking information after the recorded content has been stored in the storage medium.

Through this, restriction on copying the recorded content is implemented by using group lock locking information that corresponds to terminal group identifier information held by the client terminal apparatus; therefore, copying of recorded content stored in a storage medium of the client terminal apparatus by a terminal apparatus that has different terminal group identification information from that of the client terminal apparatus can be prevented.

In addition, the client terminal apparatus may further include a judgment unit which judges whether or not the storage medium is a portable storage medium; and in the case where the storage medium is judged by the judgment unit to be a portable storage medium, the group lock locking unit may set the restriction on copying of the recorded content using the group lock locking information after the recorded content has been stored in the portable storage medium.

Through this, copy restriction is implemented on recorded content stored in a storage medium if that storage medium is a portable storage medium; therefore, copying of recorded content stored in the portable storage medium by a terminal apparatus that has different terminal group identification information from that of the client terminal apparatus can be prevented.

In addition, the broadcast station apparatus may further hold group lock unlocking information which is associated with the terminal group identification information; and the client terminal apparatus may further include a group lock unlocking unit which acquires, from the broadcast station apparatus, the group lock unlocking information corresponding to the terminal group identification information that identifies the terminal identification list including the terminal identification information held by the client terminal apparatus, holds the group lock unlocking information, and releases the restriction on copying of the recorded content stored in the portable storage medium using the group lock unlocking information acquired from the broadcast station apparatus.

Through this, the group lock unlocking information corresponds to the terminal group identification information that identifies a terminal identification list included in the terminal identification held by the client terminal apparatus; therefore, if a terminal apparatus is one which has terminal identification information that is included in that terminal identification list, it is possible to acquire the group lock unlocking information from the broadcast station apparatus and release the restriction on copying of the recorded content stored in a portable storage medium. In other words, it is possible to limit the terminal apparatuses which can release the restriction on the copying of the recorded content to terminal apparatuses that have terminal identification information that is included in the terminal identification list. As a result, it is possible to increase the usability for the user.

To achieve the abovementioned goal, the content management system of the present invention includes a server terminal apparatus that holds, as recorded content, content broadcasted from a broadcast station apparatus, and a client terminal apparatus that requests the recorded content from said server terminal apparatus. The server terminal apparatus includes: a content storage unit which stores content broadcasted over a predetermined channel in association with an identifier of the predetermined channel as the recorded content; a server inquiry unit which receives a request to transfer the recorded content stored in said content storage unit, and inquires with the broadcast station apparatus as to whether or not transfer of the recorded content is permitted; and a first processing unit which transfers the recorded content to a transfer destination in the case where the transfer is permitted by the broadcast station apparatus. The client terminal apparatus includes a second processing unit which requests the server terminal apparatus to transfer the recorded content and stores the transferred recorded content in a storage medium.

Through this, permission on the part of the broadcast station apparatus is required when the client terminal apparatus acquires recorded content from the server terminal apparatus; therefore, it is possible to increase the degree of freedom with which the broadcast station apparatus manages the content. Moreover, no operation on the part of the user is necessary, which makes it possible to improve the user interface. In other words, it becomes possible for the broadcast station apparatus to restrict the use of recorded content stored in the server terminal apparatus.

To achieve the abovementioned goal, the content management system of the present invention includes a server terminal apparatus that holds, as recorded content, content broadcasted from a broadcast station apparatus, and a client terminal apparatus that requests the recorded content from the server terminal apparatus. The server terminal apparatus includes: a content storage unit which stores broadcasted content as the recorded content; a first terminal information holding unit which holds first terminal identification information for identifying the server terminal apparatus; a first password holding unit which acquires first password information associated with the first terminal identification information from the broadcast station apparatus and holds the first password information; a connection permission unit which compares password information sent from another terminal apparatus with the first password information held by said first password holding unit, and permits connection of the other apparatus when the password information and first password information match; and a first processing unit which receives, from the other apparatus permitted to connect by said connection permission unit, a request to transfer the recorded content stored in said content storage unit, and transfers the recorded content to a transfer destination. The client terminal apparatus includes: a second terminal information holding unit which holds second terminal identification information for identifying the client terminal apparatus; a second password holding unit which acquires second password information associated with the second terminal identification information from the broadcast station apparatus and holds the second password information; and a second processing unit which sends a second password held in the second password holding unit to the server terminal apparatus so as to connect to the server terminal apparatus, and after being permitted to connect by the server terminal apparatus, requests the transfer of the recorded content stored in the server terminal apparatus, and stores the transferred recorded content in the storage medium.

Through this, when the client terminal apparatus acquires recorded content from the server terminal apparatus, password information common to the client terminal apparatus and the server and which is received from the broadcast station apparatus is required; therefore, it is possible to increase the degree of freedom with which the broadcast station apparatus manages the content. Moreover, no operation on the part of the user is necessary, which makes it possible to improve the user interface. In other words, it becomes possible for the broadcast station apparatus to restrict the use of recorded content stored in the server terminal apparatus.

In addition, the content management system may further include the broadcast station apparatus, which includes a table holding unit which holds a terminal group management table including: a terminal identification list that has terminal identification information for identifying a terminal which can be connected to; terminal group identification information which identifies the terminal identification list; and password information corresponding to the terminal group identification information; and a password issuing unit which issues password information in response to a request for acquisition of the password information on the part of the terminal apparatuses. The client terminal apparatus and the server terminal apparatus may respectively send the first and second terminal identification information held in the first and second terminal information holding units, along with the request for acquisition of the first and the second password information; the password issuing unit may refer to the terminal group management table and issue the password information corresponding to the terminal group identification information that identifies the terminal identification list present in the received terminal identification information; and the password information may be different in each terminal group identification information.

Through this, if a terminal is not one which has terminal identification information included in the terminal identification list specified by the terminal group identification information held by the server terminal apparatus, then that terminal cannot acquire the password common with the server terminal apparatus; therefore, it is possible to prevent recorded content from being illegitimately used by a client terminal apparatus that has terminal group identification information that differs from the terminal group identification information held by the server terminal apparatus.

To achieve the abovementioned goal, the content management system of the present invention includes: a server terminal apparatus that holds, as recorded content, content broadcasted from a broadcast station apparatus; and a client terminal apparatus that requests the recorded content from the server terminal apparatus, the server terminal apparatus includes: a content storage unit which stores broadcasted content as the recorded content; a first terminal information holding unit which holds first terminal information for identifying the server terminal apparatus; a terminal identification list holding unit which acquires a terminal identification list including the first terminal identification information from the broadcast station apparatus, and hold the terminal identification list; a connection permission unit which compares terminal identification information sent from another terminal apparatus with the terminal identification information present in the terminal identification list held by the terminal identification list holding unit, and permits connection of the other apparatus when the terminal identification information matches; and a first processing unit which receives, from the other apparatus permitted to connect by the connection permission unit, a request to transfer the recorded content stored in said content storage unit, and transfers the recorded content to a transfer destination, and the client terminal apparatus includes: a second terminal information holding unit which holds second terminal identification information for identifying the client terminal apparatus; and a second processing unit which sends the second terminal identification information held in the second terminal information holding unit to the server terminal apparatus so as to connect to the server terminal apparatus, and after being permitted to connect by the server terminal apparatus, to request the transfer of the recorded content stored in the server terminal apparatus, and to store the transferred recorded content in the storage medium.

Through this, second terminal identification information of the client terminal apparatus and first terminal identification information of the server terminal apparatus must be included in the terminal identification list sent from the broadcast station apparatus when the client terminal apparatus acquires recorded content from the server terminal apparatus; therefore, it is possible to increase the degree of freedom with which the broadcast station apparatus manages the content. Moreover, no operation on the part of the user is necessary, which makes it possible to improve the user interface. In other words, it becomes possible for the broadcast station apparatus to restrict the use of recorded content stored in the server terminal apparatus.

Note that the present invention can be realized not only as the abovementioned content management system, but also as a method and a program through which the client terminal apparatus, server terminal apparatus, and so on included in the system manage content, as well as a storage medium in which that program in stored.

### FURTHER INFORMATION ABOUT TECHNICAL BACKGROUND TO THIS APPLICATION

The disclosure of U.S. Patent Application No. 60/751,314 filed on Dec. 19, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a configuration diagram of a broadcast system according to the present invention;

FIG. 2 is an example of how to use a frequency band used in communications between a system on the broadcast system side and a terminal apparatus, in a cable television system according to the present invention;

FIG. 3 is an example of how to use a frequency band used in communications between a system on the broadcast system side and a terminal apparatus, in a cable television system according to the present invention;

FIG. 4 is an example of how to use a frequency band used in communications between a system on the broadcast system side and a terminal apparatus, in a cable television system according to the present invention;

FIG. 5 is a diagram showing a configuration of a TS packet predefined by MPEG-2 specifications;

FIG. 6 is a schematic diagram of an MPEG-2 transport stream;

FIG. 7 is an example of division when a PES packet predefined by MPEG-2 specifications is transmitted using TS packets;

FIG. 8 is an example of division when an MPEG-2 section predefined by MPEG-2 specifications is transmitted using TS packets;

FIG. 9 is a diagram showing a configuration of an MPEG-2 section predefined by MPEG-2 specifications;

FIG. 10 is an example of use of an MPEG-2 section predefined by MPEG-2 specifications;

FIG. 11 is an example of use of a PMT predefined by MPEG-2 specifications;

FIG. 12 is an example of use of a PAT predefined by MPEG-2 specifications;

FIG. 13 is an example of a hardware configuration of a broadcast recording and reproduction apparatus according to the present invention;

FIG. 14 is an example of a front panel of an input unit 1310 in a hardware configuration of a terminal apparatus 1200 according to the present invention;

FIG. 15 is an example of a device connection at the time of recording, in the recording and reproduction apparatus according to the present invention;

FIG. 16 is an example of a device connection at the time of reproduction, in the recording and reproduction apparatus according to the present invention;

FIG. 17 is a diagram showing a structure of the program stored in a terminal apparatus according to the present invention;

FIG. 18 is an example of information stored in a secondary storage unit according to the present invention;

FIG. 19 is a detailed configuration of the AM 1704b according to the present invention;

FIG. 20 is a schematic diagram showing details of an AIT prescribed by the DVB-MHP standard according to the present invention;

FIG. 21 is a schematic diagram showing a file system sent in DSM-CC format according to the present invention;

FIG. 22 is an example of a record information management table according to the present invention;

FIG. 23 is an example of an EPG executed by a terminal apparatus according to the present invention;

FIG. 24 is an example of an EPG executed by a terminal apparatus according to the present invention;

FIG. 25 is an example of a type of connection between the broadcast station system and the terminal according to the present invention;

FIG. 26 is a diagram showing a detailed configuration of the copy control manager 1704p on the client side according to the present invention;

FIG. 27 is a diagram showing a detailed configuration of a copy control manager 1704p on the server side according to the present invention;

FIG. 28 is an example of a terminal group management table according to the present invention;

FIG. 29 is an example of a recording information management table which includes a group key according to the present invention;

FIG. 30 is a diagram showing a detailed configuration of a terminal group management function 2801 of the broadcast station system according to the present invention;

FIG. 31 is an example of a terminal group management table according to the present invention;

FIG. 32 is a flowchart showing an example of processing performed on the client side during copying of recorded content according to the present invention;

FIG. 33 is a flowchart showing an example of processing performed on the server side during copying of recorded content according to the present invention;

FIG. 34 is a flowchart showing an example of processing performed by the broadcast station system during copying of recorded content according to the present invention;

FIG. 35 is a diagram showing a structure of the program stored in a terminal apparatus according to the present invention;

FIG. 36 is a diagram showing a detailed configuration of the reproduction control manager 1704q in a terminal apparatus according to the present invention;

FIG. 37 is a diagram showing a detailed configuration of the terminal group management function 3601 in a terminal apparatus according to the present invention;

FIG. 38 is a flowchart showing the case where recorded content recorded into the secondary storage unit of a copy origin is reproduced, according to the present invention;

FIG. 39 is a flowchart showing the case where a terminal group management function in the broadcast station system according to the present invention issues “OK” or “NG” in response to an inquiry from a reproduction allowance inquiry unit on the terminal side;

FIG. 40 is a diagram showing a detailed configuration of a copy control manager 1704p according to the present invention;

FIG. 41 is a diagram showing a detailed configuration of the terminal group management function B01 of the broadcast station system according to the present invention;

FIG. 42 is an example of a terminal group management table according to the present invention;

FIG. 43 is a diagram showing a detailed configuration of a copy control manager 1704p according to the present invention; and

FIG. 44 is a diagram showing a detailed configuration of the terminal group management function E01 of the broadcast station system according to the present invention.

### DESCRIPTION OF THE PREFERRED EMBODIMENTS

### First Embodiment

Hereafter, an apparatus and a method according to the first embodiment of the present invention shall be described with reference to the drawings. The present invention is aimed at recording and reproduction of a content sent and received with an arbitrary medium; however, in the present embodiment, a cable television broadcast system is described as an example. In the cable television broadcast system, a broadcast recording and reproduction apparatus, as in the present invention, is generally called a terminal apparatus.

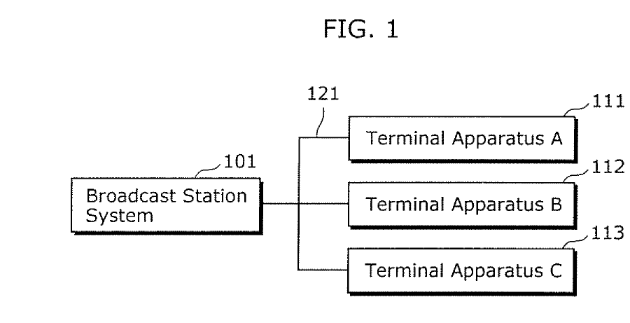

FIG. 1 is a block diagram showing a relationship of apparatuses that make up a broadcast system (content management system). The content management system is made up of a broadcast station system (broadcast station apparatus) 101 and three terminal apparatuses, or a terminal apparatus A111, a terminal apparatus B112, and a terminal apparatus C113. A coupling 121 between the broadcast station system and each terminal apparatus is, in the cable system, a wired coupling such as a coaxial cable, a fiber-optic cable, and the like. In FIG. 1, one broadcast station system is coupled with three terminal apparatuses, but any number of terminal apparatuses may be used.

The broadcast station system 101 sends information such as video/audio/data for data broadcast in a broadcast signal to a plurality of terminal apparatuses. The broadcast signal is sent using a frequency within a frequency band set by an operational default of the broadcast system, the laws of a country/region in which the broadcast system is operated, and so on.

With the cable system in the present embodiment, the frequency band used in broadcast signal transmission is divided into the data details and transmission direction (inbound, outbound) and applied.

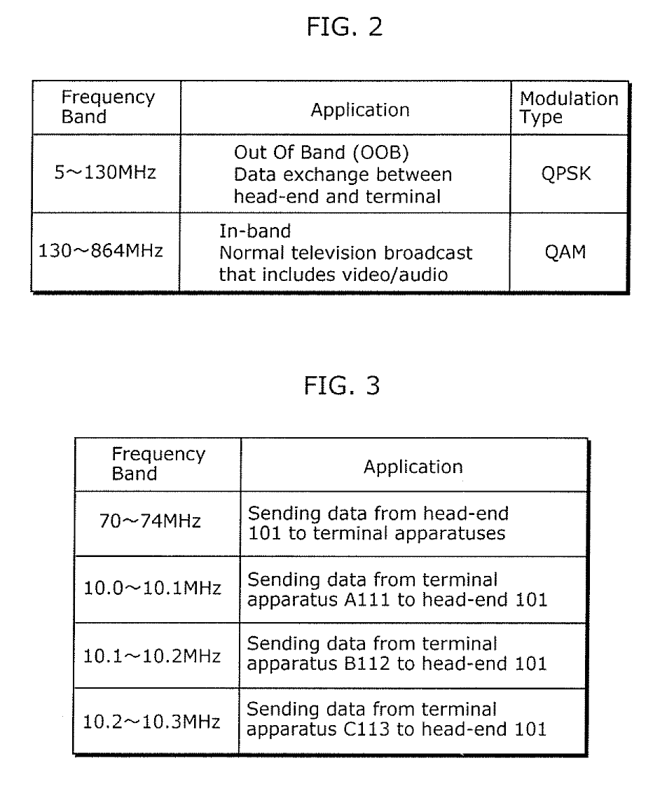

FIG. 2 is a table showing an example of divided frequency bands. The frequency bands can be roughly divided into two types: Out of Band (abbr. “OOB”) and In-Band. 5 MHz to 130 MHz is assigned as OOB, and is mainly used in data exchange between the broadcast station system 101 and the terminal apparatus A111, the terminal apparatus B112, and the terminal apparatus C113. 130 MHz to 864 MHz is assigned as In-Band, and is mainly used in an outbound-only broadcast channel that includes video/audio. QPSK modulation type is used with OOB, and QAM64 or QAM256 modulation type is used with In-Band. A detailed explanation of modulation techniques shall be omitted here, since they are publicly known techniques which are of little relation to the present invention.

FIG. 3 is one example of a more detailed use of the OOB frequency band. 70 MHz to 74 MHz is used in outbound data sending from the broadcast station system 101, and each of the terminal apparatus A111, B112, C113 receives the same data from the broadcast station system 101. On the other hand, 10.0 MHz to 10.1 MHz is used in inbound data sending from the terminal apparatus A111 to the broadcast station system 101; 10.1 MHz to 10.2 MHz is used in inbound data sending from the terminal apparatus B112 to the broadcast station system 101; and 10.2 MHz to 10.3 MHz is used in inbound data sending from the terminal apparatus C113 to the broadcast station system 101. Through this, it is possible for each of the terminal apparatuses A111, B112, and C113 to independently send data unique to that terminal apparatus to the broadcast station system 101.

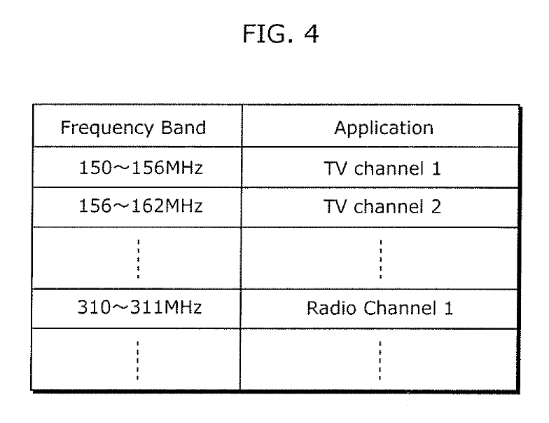

FIG. 4 shows an example use of the In-Band frequency band. Frequency bands of 150 to 156 MHz and 156 to 162 MHz are allocated to television channels 1 and 2 respectively; television channels are allocated in 6 MHz intervals thereafter. 310 MHz and the subsequent frequencies are allocated to radio channels in 1 MHz units. Each of these channels may be used for analog or digital broadcast. Digital broadcast is sent in TS packet format in accordance with the MPEG-2 specifications, and in addition to audio and video, it is also possible to send data for various data broadcast and TV program composition information for configuring an EPG.

The broadcast station system 101 uses the frequency bands described above to send an appropriate broadcast signal to the terminal apparatuses, and therefore has a QPSK modulation unit, a QAM modulation unit, and so on. In addition, the broadcast station system 101 has a QPSK demodulator for receiving data from the terminal apparatuses. Moreover, the broadcast station system 101 can be thought of as having various devices related to the modulation units and the demodulation unit. However, detailed explanations of these shall be omitted here, since the present invention is mainly related to the terminal apparatuses.

The terminal apparatuses A111, B112, and C113 each have a QAM demodulation unit and a QPSK demodulation unit in order to receive and reproduce a broadcast signal from the broadcast station system 101. In addition, each terminal apparatus has a QSPK modulation unit in order to send data, which is unique to each terminal apparatus, to the broadcast station system 101. In the present invention, the terminal apparatuses are broadcast recording and reproduction apparatuses, and detailed configurations shall be described later.

The broadcast station system 101 modulates an MPEG-2 transport stream and transmits the stream within the broadcast signal. A terminal apparatus receives the broadcast signal, demodulates and reproduces the MPEG-2 transport stream, extracts necessary information from the stream, and uses that information. In order to describe device functions and connection structures present in the terminal apparatus, the structure of the MPEG-2 transport stream shall first be described in simple terms.

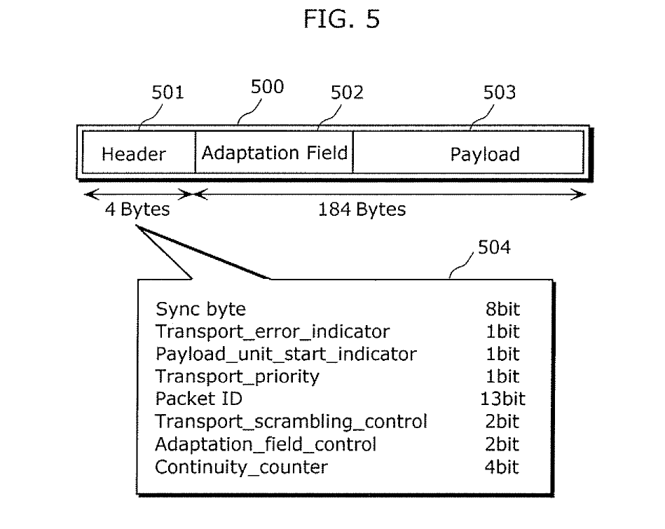

FIG. 5 is a diagram showing the structure of a TS packet. A TS packet 500 has a length of 188 bytes, and is composed of a header 501, an adaptation field 502, and a payload 503. The header 501 holds control information of the TS packet, has a length of 4 bytes, and is structured as shown in 504. In the header 501 there is a field denoted as “Packet ID” (hereafter, PID), and the TS packet is identified through the value of this PID. The adaptation field 502 holds additional information such as time information. The adaptation field 502 is not mandatory, and there are cases where the adaptation field 502 is not present. The payload 503 holds information transmitted by the TS packet, such as video, audio, and data used for data broadcast.

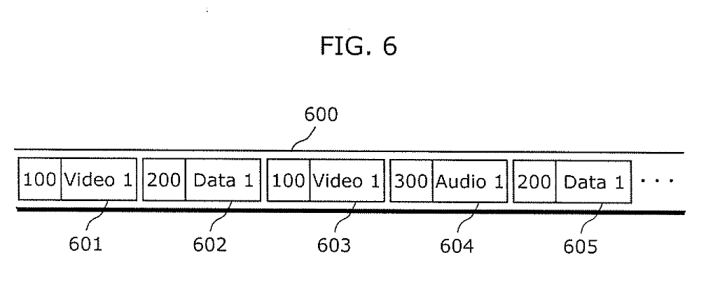

FIG. 6 is a schematic diagram of an MPEG-2 transport stream. The TS packet holds various information in the payload, such as video, audio, data used for data broadcast, and the like. A TS packet 601 and a TS packet 603 hold a PID 100 in the header, and hold information regarding video 1 in the payload. A TS packet 602 and a TS packet 605 hold a PID 200 in the header, and hold information regarding data 1 in the payload. A TS packet 604 holds a PID 300 in the header, and holds information regarding audio 1 in the payload. Mixing TS packets which hold various types of data in the payloads and transmitting these as a series in sequence is called multiplexing. An MPEG-2 transport stream 600 is one example of a configuration in which the TS packets 601 to 605 are multiplexed.

TS packets that have identical PIDs hold identical types of information. Therefore, the terminal apparatus reproduces video and audio, and reproduces data such as TV program composition information, by receiving multiplexed TS packets and extracting, per PID, the information that the TS packet holds. In FIG. 6, the TS packet 601 and the TS packet 603 each transmit information regarding the video 1, and the TS packet 602 and the TS packet 605 each transmit information regarding the data 1.

Here, description shall be given regarding a format of each type of data contained in the payload.

Video and audio are expressed by a format called a Packetized Elementary Stream (PES) packet. The PES packet includes video information or audio information of a certain time period, and by receiving the PES packet, the broadcast recording and reproduction apparatus can output the video and audio information contained in that PES packet to a screen and speaker. The broadcast station transmits the PES packets without pause, and therefore it is possible for the broadcast recording and reproduction apparatus to continuously reproduce the video and audio without pause. When the PES packet is actually transmitted, it is divided and stored in the payloads of a plurality of TS packets in the case where the PES packet has a size larger than that of the payload of one TS packet.

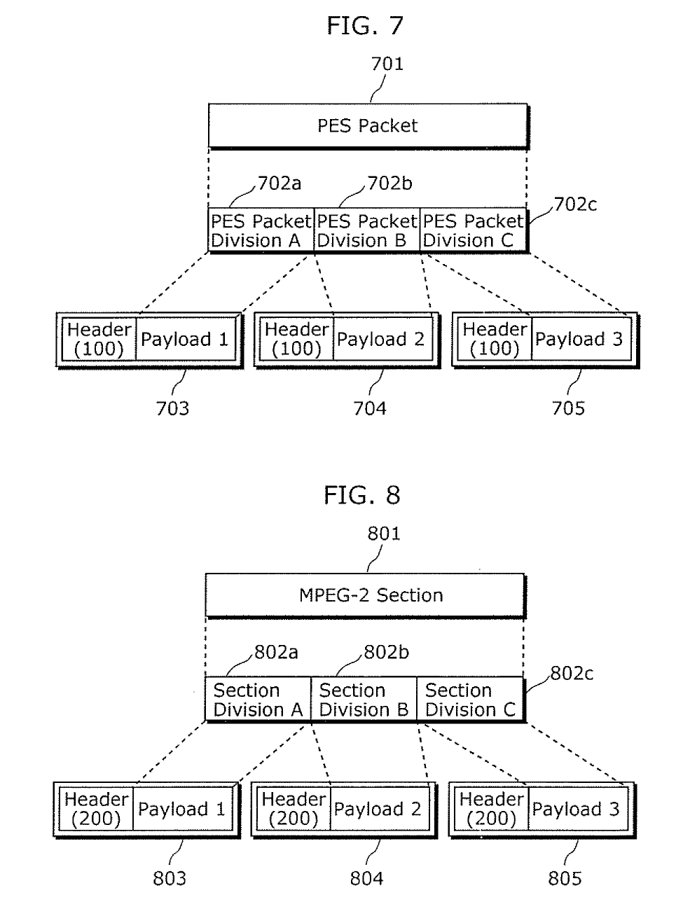

FIG. 7 shows an example of division when a PES packet is transmitted. A PES packet 701 is too large to be stored and transmitted in a payload of a single TS packet, and therefore the PES packet 701 is divided into a PES packet division A 702a, a PES packet division B 702b, and a PES packet division C 702c, and is transmitted by three TS packets 703 to 705 which have identical PIDs. In actuality, the video and audio is obtained as an elementary stream (ES) that is obtained by concatenating data contained in the payloads of a plurality of PES packets. The format of this elementary stream is digitalized video and audio, such as defined by so the MPEG-2 Video standard, the MPEG-1 and 2 Audio standard, and the like.

On the other hand, information such as the TV program composition information and data used for data broadcast is expressed using a format called an MPEG-2 section. When the MPEG-2 section is actually transmitted, the MPEG-2 section is divided and stored in the payloads of a plurality of TS packets in the case where the MPEG-2 section has a size larger than the payload of one TS packet.

FIG. 8 shows an example of division when the MPEG-2 section is transmitted. As an MPEG-2 section 801 is too large to be stored and transmitted in a payload of a single TS packet, the MPEG-2 section 801 is divided into a section division A 802a, a section division B 802b, and a section division C 802c, and is transmitted by three TS packets 803 to 805 which have identical PIDs.

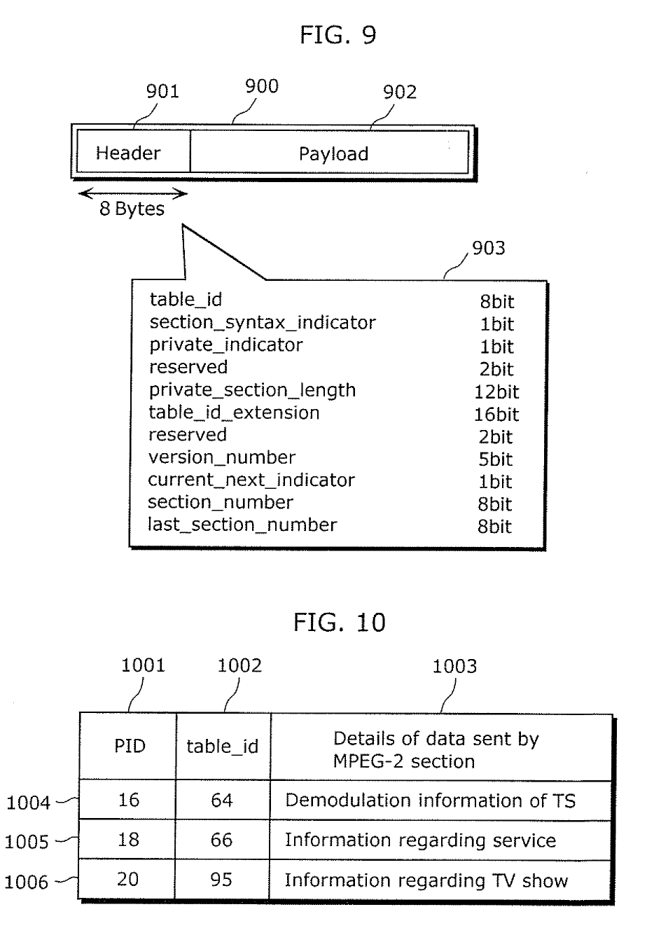

FIG. 9 expresses a structure of the MPEG-2 section. An MPEG-2 section 900 is configured of a header 901 and a payload 902. The header 901 holds control information of the MPEG-2 section. That configuration is expressed by a header configuration 903. The payload 902 holds data transmitted by the MPEG-2 section 900. A table_id present in the header configuration 903 expresses the type of the MPEG-2 section, and a table_id_extension is an extension identifier used when further distinguishing between MPEG-2 sections with an identical table_id.

FIG. 10 is a diagram showing the case where the TV program composition information is transmitted, which is an example of use of the MPEG-2 section. In this example, as written in row 1004, information necessary for demodulating the broadcast signal is denoted in the MPEG-2 section which has a table_id of 64 in the header structure 903; furthermore, this MPEG-2 section is carried by a TS packet with a PID of 16.

The PES format does not exist in the case of the MPEG-2 section. For that reason, the elementary stream (ES) is obtained when the payloads of TS packets identified by identical PIDs within the MPEG-2 transport stream are concatenated. For example, in FIG. 8, the TS packets 803 to 805, in which the MPEG-2 section 801 is divided and transmitted, all are identified with the PID of 200. It can be said that this is an ES which transmits the MPEG-2 section 801.

A concept called a program further exists in the MPEG-2 transport stream. The program is expressed as a collection of ESs, and is used in the case where handling a plurality of ESs all together is desirable. When the program is used, it is possible to handle video/audio, as well as accompanying data broadcast data, all together. For example, in the case of simultaneously handling the video/audio to be reproduced, by grouping the video ES and the audio ES as a program, it can be seen that the broadcast recording and reproduction apparatus should simultaneously reproduce these two ESs as one TV program.

To express the program, two tables, called a Program Map Table (PMT) and a Program Association Table (PAT), are used in MPEG-2. Detailed descriptions can be found in the specifications of ISO/IEC 13818-1, “MPEG-2 Systems.” The PMT and the PAT shall be briefly described hereafter.

The PMT is a table, the number of which is equal to the number of programs included in the MPEG-2 transport stream. The PMT is configured as an MPEG-2 section, and has a table_id of 2. The PMT holds a program number used in identifying the program and additional information of the program, as well as information regarding an ES belonging to the program.

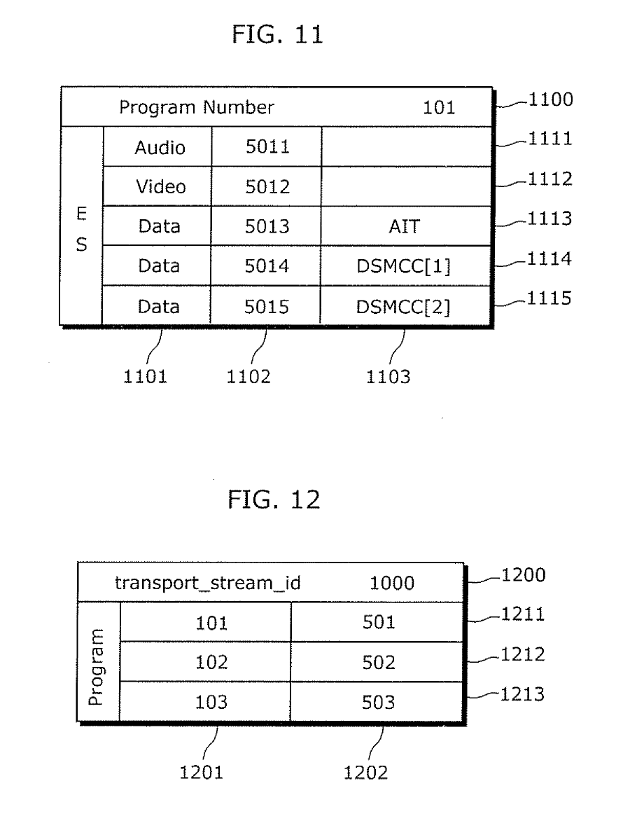

FIG. 11 is a diagram showing an example of the PMT. 1100 is a program number. The program number is assigned uniquely to programs in the same transport stream, and is used in identifying the PMT. Rows 1111 to 1115 express information regarding individual ESs. Column 1101 is the type of ES, in which “video”, “audio”, “data”, and so on are specified. Column 1102 is the PID of the TS packets that make up the ES. Column 1103 is additional information regarding the ES. For example, the ES shown in row 1111 is an audio ES, and is transmitted by TS packets with a PID of 5011.

The PAT is a table, of which only one is present, in the MPEG-2 transport stream. The PAT is configured as an MPEG-2 section, has a table_id of 0, and is transmitted by a TS packet with a PID of 0. The PAT holds a transport_stream_id used in identification of the MPEG-2 transport stream, and information regarding all PMTs that represent a program existing in the MPEG-2 transport stream.

FIG. 12 is a diagram showing an example of the PAT. 1200 is a transport_stream_id. The transport_stream_id is used in identifying the MPEG-2 transport stream. Rows 1211 to 1213 express information regarding the program. Column 1201 is the program number. Column 1202 is the PID of the TS packet which sends the PMT that corresponds to the program. For example, the PMT of the program shown in row 1211 has a program number of 101, and the corresponding PMT is transmitted by the TS packet with a PID of 501.

In the case where the terminal apparatus reproduces a certain program, the terminal apparatus uses the PAT and the PMT and specifies the video and audio that make up a program, and reproduces that video and audio. For example, in regards to the MPEG-2 transport stream that transmits the PAT in FIG. 12 and the PMT in FIG. 11, the following procedure is followed in the case where the video and audio belonging to the program with a program number of 101 are reproduced. First, a PAT transmitted as an MPEG-2 section with a table_id of “0” is acquired from a TS packet with a PID of “0”. The PAT is searched for a program with the program number “101”, and row 1211 is obtained. From row 1211, the PID “501”, of the TS packet which transmits the PMT of the program with a program number “101”, is obtained. Next, the PMT transmitted as the MPEG-2 section with a table_id of “2” is acquired from the TS packet with the PID of “501”. Row 1111, which is audio ES information, and row 1112, which is video ES information, are obtained from the PMT. A PID “5011” of the TS packet which transmits the audio ES is obtained from row 1111. In addition, a PID “5012” of the TS packet which transmits the video ES is obtained from row 1112. Next, an audio PES packet is acquired from the TS packet with a PID “5011”, and a video PES packet is acquired from the TS packet with a PID of “5012”. Through this, it is possible to acquire the video and audio ES packets to be reproduced, and the video and audio that make up the program number 101 can be reproduced.

Note that there are cases where the MPEG-2 transport stream is scrambled. This is a setup called limited viewing. For example, by scrambling the PES packets which transmit a certain video and audio, only specified viewers who can descramble the PES packets are able to view that video and audio. In order to descramble and view the video and audio, a viewer must perform descrambling using a device called a descrambler. For example, in an OCAP-compatible terminal apparatus, a card-form adapter with an internal descrambler is used. A cable television operator distributes an adapter configured to be able to decode a specified program to each viewer, and the viewer inserts that adapter into the terminal apparatus. Upon doing so, the adapter descrambles the specified program based on descrambling information such as a descrambling key and contract information of each contract holder. A method of descrambling, a method of obtaining the descrambling key, and the like depend on the adapter, and have no influence on the realization of the present invention.

Thus far, simple descriptions regarding the MPEG-2 specifications have been; hereafter, detailed definitions of terminology shall be given. In the present invention, two types of the term “program” exist. One is a “program” which appears in the MPEG-2 specifications, and the other is a “program” referring to an assemblage of code executed by a CPU. As the former is synonymous with the term “service” used in the operation regulations, hereafter, to avoid confusion, the former is called a “service” and the latter is simply called a “program”. Furthermore, concerning the latter, a “program” particularly written in the Java language is called a “Java program”.

Description has been given regarding several kinds of general information specified in the MPEG-2 specifications according to the present invention. Hereafter, the broadcast recording and reproduction terminal used in the present embodiment shall be described in detail.

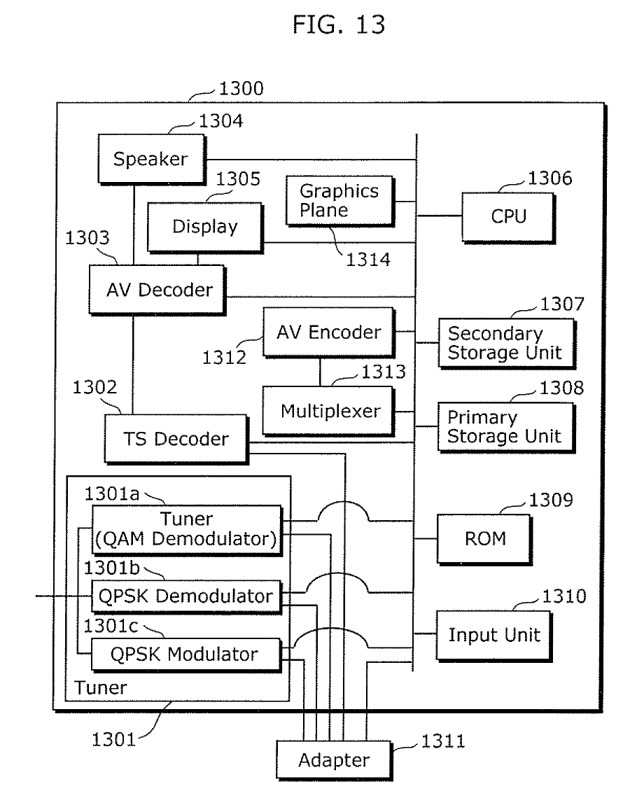

FIG. 13 is a block diagram showing a general hardware configuration of the broadcast recording and reproduction apparatus according to the present embodiment; in other words, a specific internal configuration of the terminal apparatuses 111, 112, and 113 shown in FIG. 1. 1300 is a broadcast recording and reproduction apparatus, which is configured of: a tuner 1301; a TS decoder (TS Demultiplexer) 1302; an AV decoder 1303; a speaker 1304; a display 1305; a CPU 1306; a secondary storage unit 1307; a primary storage unit 1308; a ROM 1309; an input unit 1310; an adapter 1311; an AV encoder 1312; a multiplexer (MPEG-2 Transport Stream Multiplexer or the like) 1313; and a graphics plane 1314. Note that the present embodiment is obtained by expanding a broadcast recording and reproduction terminal implemented by the OCAP-DVR specifications, and the specific hardware configuration is nearly identical to that required by the OCAP-DVR specifications.

The tuner 1301 is a device which demodulates a broadcast signal modulated and transmitted from the broadcast station system 101, in accordance with tuning information including a frequency prescribed by the CPU 1306. Here, the tuning information is information that can specify a frequency, a modulation method, and the like. The MPEG-2 transport stream obtained as a result of the demodulation performed by the tuner 1301 passes through the adapter 1311, which has a descrambling function, and is sent to the TS decoder 1302.

The TS decoder 1302 is a device which has a function to segregate PES packets and MPEG-2 sections which comply with specified conditions from the MPEG-2 transport stream, based on a PID, a section filter condition, and so on prescribed by the CPU 1306. In the case where a broadcast is received and a service is reproduced without recording, the MPEG-2 transport stream which the adapter 1311 outputs is inputted to the TS decoder 1302. On the other hand, in the case of reproducing a service recorded in the secondary storage unit 1307, the MPEG-2 transport stream which the secondary storage unit 1307 outputs is inputted to the TS decoder 1302. Which input to receive is controlled by the CPU 1306.

The PES packets of the video and audio which the TS decoder 1302 segregated are outputted to the AV decoder 1303. In addition, the MPEG-2 section segregated by the TS decoder 1302 is transferred to the primary storage unit 1308 through Direct Memory Access (DMA), and is used by a program executed by the CPU 1306.

The AV decoder 1303 is a device with a function to decode the encoded video ES and audio ES. The AV decoder fetches the ES from the PES packet that transmits the audio and video information sent from the TS decoder, and decodes the ES. An audio signal and a video signal obtained through the decoding performed by the AV decoder 1303 are sent to the speaker 1304 and the display 1305 at the time of service reproduction, but are sent to the AV encoder 1312 at the time of service recording. Which output route to take is controlled by the CPU 1306 in accordance with instructions from the user.

The speaker 1304 reproduces audio outputted from the AV decoder 1303.

The display 1305 reproduces video outputted from the AV decoder 1303, and displays graphics on the graphics plane 1314 drawn by the CPU.

The CPU 1306 executes a program that operates in the broadcast recording and reproduction apparatus. The CPU 1306 executes a program contained in the ROM 1309. Or, the CPU 1306 executes a program downloaded from a broadcast signal or a network and held in the primary storage unit 1308. Or, the CPU executes a program downloaded from a broadcast signal or a network and held in the secondary storage unit 1307. The tuner 1301, TS decoder 1302, AV decoder 1303, speaker 1304, display 1305, secondary storage unit 1307, primary storage unit 1308, ROM 1309, input unit 1310, adapter 1311, AV encoder 1312, multiplexer 1313 and graphics plane 1314 are controlled in accordance with the instruction of the executed program. In addition, the CPU 1306 may communicate not only with devices present within the terminal apparatus 1300, but also with the devices within the adapter 1311, and may control the adapter 1311.

The secondary storage unit 1307 is a memory apparatus, the memory of which is not deleted even if the power supply to the device is interrupted; for example, a nonvolatile memory such as a FLASH-RON, a Hard Disk Drive (HDD), a rewritable media such as a CD-R (Compact Disc-Recordable) and a DVD-R (Digital Versatile Disc-Recordable). The secondary storage unit 1307 saves information based on an instruction from the CPU 1306.

The primary storage unit 1308 is a device which has a function for temporarily saving information in accordance with an instruction from the CPU 1306, a device that can perform DMA transfers, and so on, and is configured of a RAM or the like.

The ROM 1309 is a non-rewritable memory device, and to be more specific, is configured of a ROM, a CD-ROM, a DVD, and the like. The program which the CPU 1306 executes is stored in the ROM 1309.

The input unit 1310 is, to be more specific, configured of a front panel or a remote control, and accepts an input from the user.

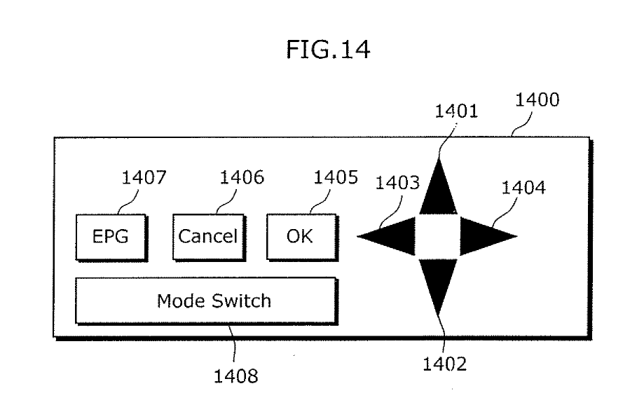

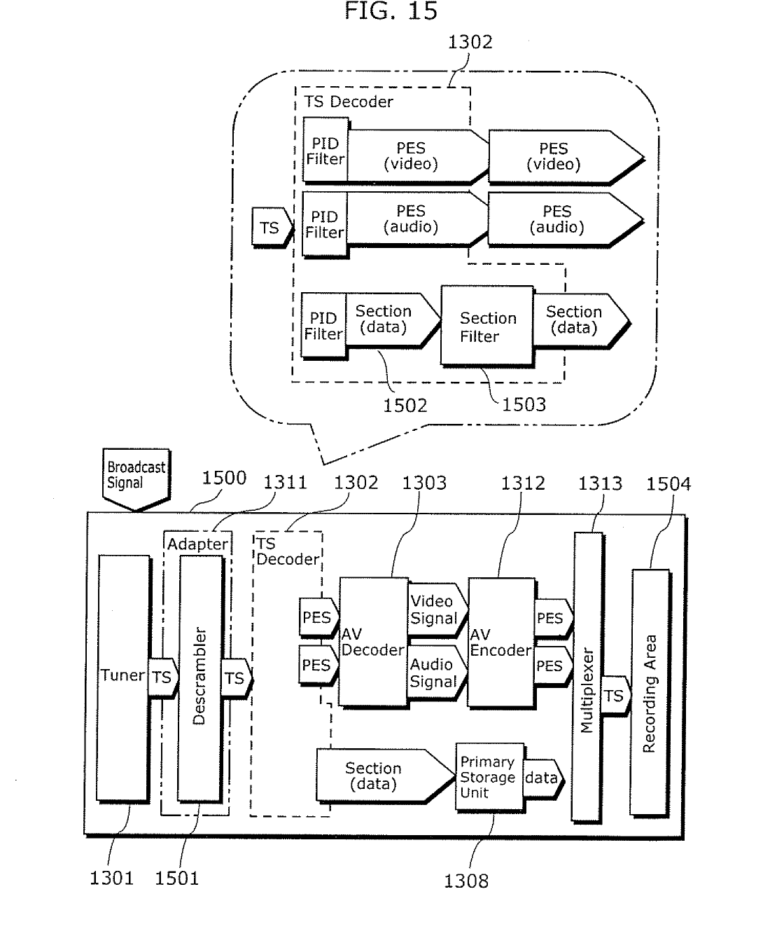

FIG. 14 is one example of a case where the input unit 1310 is configured of the front panel. A front panel 1400 has seven buttons: an up cursor button 1401, a down cursor button 1402, a left cursor button 1403, a right cursor button 1404, an OK button 1405, a cancel button 1406, an EPG button 1407, and a mode switch button 1408. When the user presses a button, the CPU 1306 is notified of an identifier of the pressed button.

The adapter 1311 is a device for descrambling the MPEG-2 transport stream sent in the In-band frequency range, and includes one or more descramblers. The MPEG-2 transport stream outputted by the tuner 1301a is inputted into the adapter 1311, and the TS packet that has the PID specified by the CPU 1306 is descrambled. The adapter 1311 outputs the descrambled MPEG-2 transport stream to the TS decoder 1302.

Furthermore, the adapter 1311 carries out format conversion of data sent in an OOB frequency range. Information that is sent OOB is modulated in the QPSK modulation format. Regarding outbound transmission, the QPSK demodulator 1301b demodulates the outbound signal sent from the broadcast station system 101, and inputs a generated bit stream into the adapter 1311. The adapter 1311 extracts information specified by the CPU 1306 from among various information included in the bit stream, converts the information to a format that can be interpreted by a program that operates in the CPU 1306, and provides this to the CPU 1306. On the other hand, regarding incoming transmission, the CPU 1306 inputs information to be sent to the broadcast station system 101 into the adapter 1311. The adapter 1311 converts the information inputted from the CPU 1306 to a format that can be interpreted by the broadcast station system 101, and inputs this to the QPSK modulator 1301c. The QPSK modulator 1301c QPSK-modulates the information inputted from the adapter 1311, and sends this to the broadcast station system 101.

A CableCARD, formerly called a Point of Deployment (POD), used in the United States cable system, can be given as a specific example of the adapter 1311.

The AV encoder 1312 encodes the audio signal decoded by the AV decoder 1303 into audio in the MPEG audio format, and encodes the video signal into video in the MPEG video format. The AV encoder 1312 outputs the encoded video and audio to the multiplexer 1313.

The multiplexer 1313 is a device with a function to multiplex the video and audio inputted from the AV encoder 1312 into the MPEG-2 transport stream.

The graphics plane 1314 is a device having a function of temporarily holding graphics drawn by the CPU. Graphics drawn on the graphics plane 1314 are merged with video outputted from the AV decoder 1303 and displayed on the display 1305, in accordance with an instruction from the CPU to transfer the graphics to the display 1305.

A process in which the broadcast recording and reproduction apparatus described above records a service contained in a broadcast signal into the secondary storage unit 1307, and a process where the broadcast recording and reproduction apparatus consecutively reads out and reproduces the service from the secondary storage unit 1307, shall be described hereafter in detail.

First, the process in which the service contained in the broadcast signal is recorded into the secondary storage unit 1307 shall be described.

FIG. 15 shows a conceptual rendering which expresses the physical connection sequence, processing details, and input/output data format of each device during recording of the service. 1500 is a terminal apparatus, which has: the tuner 1301; the adapter 1311; a descrambler 1501; the TS decoder 1302; a PID filter 1502; a section filter 1503; the AV decoder 1303; the primary storage unit 1308; the AV encoder 1312; the multiplexer 1313; and a recording area 1504. Constituent elements in FIG. 15 that have the same numbers as in FIG. 13 have the same functions and thus description in omitted.

First, the tuner 1301 performs tuning on the broadcast signal in accordance with tuning information specified by the CPU 1306. Here, the tuning information is information that can specify a frequency, a modulation method, and the like. The tuner 1301 demodulates the broadcast signal and inputs the MPEG-2 transport stream into the adapter 1311.

The descrambler 1501, which is within the adapter 1311, descrambles the MPEG-2 transport stream based on limitation removal information for each viewer. The descrambled MPEG-2 transport stream is inputted into the TS decoder.

Two types of devices that process the MPEG-2 transport stream are present within the TS decoder 1302: the PID filter 1502 and the section filter 1503.

The PID filter 1502 extracts, from the inputted MPEG-2 transport stream, a TS packet that has a PID specified by the CPU 1306, and then extracts a PES packet and an MPEG-2 section present in that payload. For example, when the MPEG-2 transport stream in FIG. 6 is inputted in the case where the CPU 1306 has instructed PID filtering, which extracts the TS packet with a PID of 100, packets 601 and 603 are extracted, then concatenated, and thus a PES packet of the video 1 is reconfigured. Or, when the MPEG-2 transport stream in FIG. 6 is inputted in the case where the CPU 1306 has instructed PID filtering, which extracts the TS packet with a PID of 200, packets 602 and 605 are extracted, then concatenated, and thereby an MPEG-2 section the data 1 is reconfigured.

The section filter 1503 extracts the MPEG-2 section which conforms to a section filter condition specified by the CPU 1306 from among the inputted MPEG-2 sections, and DMA-transfers this MPEG-2 section to the primary storage unit 1308. For example, the CPU 1306 specifies PID filtering which extracts the TS packet with a PID of 200, and section filtering which extracts a section with a table_id of 64. As mentioned earlier, after the MPEG-2 section of the data 1 is reconfigured, the section filter 1503 extracts only the section with a table_id of 64 from among those MPEG-2 sections, and DMA-transfers this to the primary storage unit 1308.

The MPEG-2 section that is inputted into the primary storage unit 1308 is inputted into the multiplexer 1313.

A video PES packet and an audio PES packet extracted by the TS decoder 1302 are inputted into the AV decoder 1303.

The AV decoder decodes the video PES packet and converts the resultant into video, and inputs this into the AV encoder 1312. The AV decoder also decodes the audio PES packet and converts the resultant into audio, and inputs this into the AV encoder 1312.

The AV encoder 1312 converts the video into MPEG video and inputs this into the multiplexer 1313. The AV encoder 1312 also converts the audio into MPEG audio and inputs this into the multiplexer 1313.

The multiplexer 1313 multiplexes the MPEG video and MPEG audio inputted from the AV encoder onto the MPEG-2 section inputted from the primary storage unit 1308, and thus generates an MPEG-2 transport stream. The generated MPEG-2 transport stream is recorded into the recording area 1504.

The recording area 1504 is made up of all or a part of the secondary storage unit 1307, or an other recording area, and records the MPEG-2 transport stream that makes up a service.

Next, the process in which the MPEG-2 transport stream is sequentially read out from the secondary storage unit 1307 (that is, the recording area 1504, in which the MPEG-2 transport stream has been recorded in accordance with the abovementioned processing) and the service reproduced shall be described.

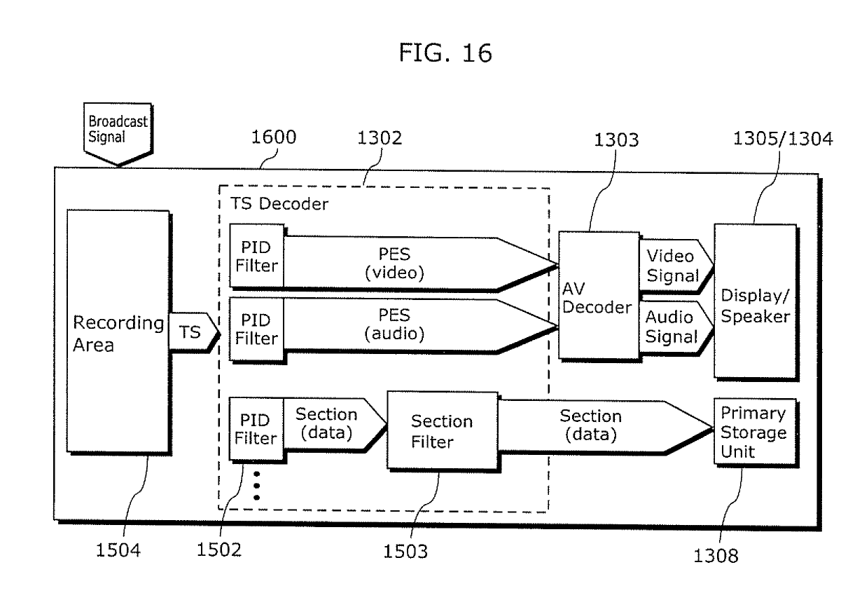

FIG. 16 shows a conceptual rendering which expresses the physical connection sequence, processing details, and input/output data format of each device during reproduction of the service. 1600 is a terminal apparatus, which has: the recording area 1504; the TS decoder 1302; the PID filter 1502; the section filter 1503; the AV decoder 1303; the speaker 1304; the display 1305; and the primary storage unit 1308. Constituent elements in FIG. 16 that have the same numbers as in FIG. 13 have the same functions and thus descriptions shall be omitted.

The MPEG-2 transport stream recorded in the recording area 1504 in the procedure illustrated in FIG. 15 is inputted into the TS decoder 1302.

Then, a video PES and an audio PES that have a PID specified by the CPU 1306 are extracted by the PID filter 1502 within the TS decoder 1302. The extracted PES packet is inputted into the AV decoder 1303. Or, the MPEG-2 section that has a PID and a table_id specified by the CPU 1306 is extracted by the PID filter 1502 and the section filter 1503 within the TS decoder 1302. The extracted MPEG-2 section is DMA-transferred to the primary storage unit 1308.

The video PES and the audio PES inputted into the AV decoder 1303 are decoded, and outputted as an audio signal and a video signal. After that, the audio signal and the video signal are inputted into the display 1305 and the speaker 1304, and thus the audio and the video are reproduced.

The MPEG-2 section inputted into the primary storage unit 1308 is inputted into the CPU 1306 as appropriate.

Thus far, an example of a hardware configuration regarding the present invention has been described. Hereafter, a chief function of the present invention, which is recording control and copy control of the service via a Java program, is described.

Recording of the service in the present invention refers to recording video, audio, a Java program, synchronization information of the Java program, and so on that are contained in the service, into an arbitrary storage medium such as a hard disk, a Blu-ray Disc (BD), a Digital Versatile Disc (DVD), and a Secure Digital (SD) memory card. Reproduction of the service refers to execution and reproduction of the video, audio, and Java program recorded in the recording medium based on the synchronization information of the Java program. A result of reproducing a recorded service is required to be almost equivalent to a result of directly reproducing the service upon receiving a broadcast signal.

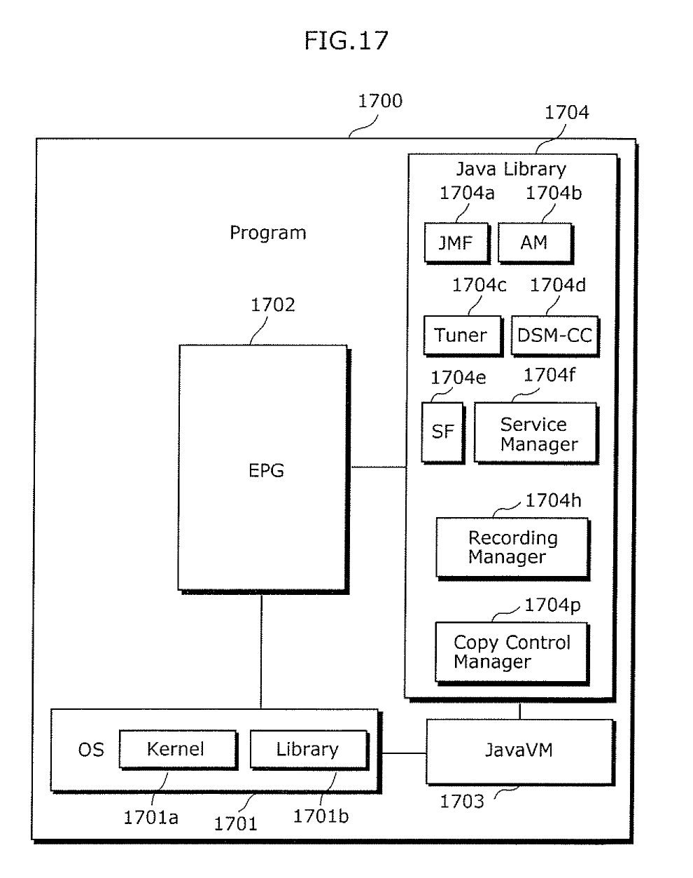

FIG. 17 is a configuration diagram of a program necessary for recording and reproduction of the service, and is software recorded into the ROM 1309.

A program 1700 is made up of an OS 1701, an EPG 1702, a Java VM 1703, and a Java library 1704, which are sub-programs.

The OS 1701 is an Operating System; Linux, Windows, and the like are examples. The OS 1701 is made up of: a kernel 1701a for executing other sub-programs such as the EPG 1702 and the Java VM 1703; and a library 1701b which the sub-programs use to control the constituent elements of the terminal apparatus 1300. The kernel 1701a is publicly-known technology and therefore detailed descriptions are omitted.

The library 1701b provides, for example, a tuning function for controlling the tuner The library 1701b accepts, from another sub-program, tuning information by which a frequency, modulation method and the like can be specified, and supplies this to the tuner 1301. The tuner 1301 performs demodulation processing based on the provided tuning information, and can pass the demodulated MPEG-2 transport stream to the TS decoder 1302. As a result, other sub-programs can control the tuner 1301 through the library 1701b.

Also, the library 1701b provides channel information for uniquely identifying a channel.

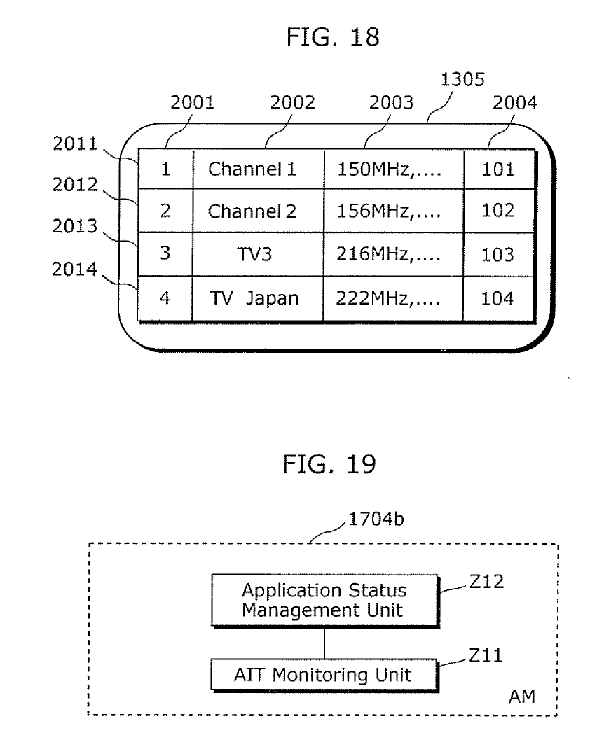

FIG. 18 is a diagram showing an example of the channel information. The channel information is sent using an OOB or an In-band frequency range, is converted into a chart format by the adapter 1311, and is stored in the primary storage unit 1308, which is accessible by the library. Column 2001 is a channel identifier, and is equivalent to, for example, a source ID as defined by SCTE65 Service Information Delivered Out-Of-Band For Digital Cable Television. Column 2002 is a channel name, and is equivalent to a source_name in the same SCTE65 standard. Column 2003 is tuning information, and is information by which a frequency, a transfer rate, a modulation method, and the like can be specified, that is given to the tuner 1301. Column 2004 is a program number for specifying the PMT. For example, row 2011 is a group of service information including a channel identifier of “1”, a channel name of “channel 1”, a frequency of “150 MHz . . . ” in the tuning information, and a program number of “101”.

The Java VM 1703 is a Java virtual machine that sequentially analyzes and executes programs written in the Java™ language. Programs written in the Java language are compiled into intermediate code known as bytecode which does not depend on hardware. The Java virtual machine is an interpreter that executes such bytecode. The Java VM 1703 executes the Java library 1704 that is written in the Java language. Details of the Java language are explained in publications such as “Java Language Specification” (ISBN 0-201-63451-1) and “Java Virtual Machine Specification” (ISBN 0-201-63451-X). In addition, it is possible to call or be called by other sub-programs not written in the Java language through a Java Native Interface (JNI). Details regarding the JNI can be found in the book “Java Native Interface” and so on.

The Java library 1704 is a library written in the Java language and which is called by the Java program in order to control functions of the broadcast recording and reproduction apparatus. However, there are situations where a sub-program not written in the Java language, such as the library 1701b of the OS 1701, is used as necessary. The Java program can use a function provided by the Java library 1740 by calling a Java Application Programming Interface (API) held by the Java library 1704.

A tuner 1704c is a Java library for controlling the In-band receiving tuner 1301a in the broadcast recording and reproduction terminal. When the Java program passes tuning information to the tuner 1704c, the tuner 1704 uses that information to invoke a tuning function of the library 1701b, and as a result, it is possible to control an operation of the In-band receiving tuner 1301a of the broadcast recording and reproduction terminal. Here, the tuning information is information that can specify a frequency, a modulation method, and the like.

An SF 1704e is a Java library for controlling a function of the PID filter 1502 and the section filter 1503 of the broadcast recording and reproduction terminal. When the Java program passes filtering conditions such as a PID, table_id, and the like to the SF 1704e, the SF 1704e uses a function of the library 1701b based on those conditions, controls the PID filter 1502 and the section filter 1503, acquires an MPEG-2 section that fulfills desirable filter conditions, and passes the MPEG-2 section to the Java program that set the filter conditions.

A DSM-CC 1704d is a Java library for accessing a DSM-CC object carousel file system. The DSM-CC object carousel is included in the MPEG-2 section acquired by the SF 1704e. The DSM-CC is defined by the ISO/IEC 13818-6 standard, and is a mechanism for using the MPEG-2 section to send an arbitrary file. By using this, it is possible to send a file from a broadcast station to a terminal. Based on a file identifier and the like specified by the Java program and so on, the DSM-CC 1704d uses the SF 1704e and acquires the MPEG-2 section, fetches a file in accordance with the ISO/IEC 13818-6 standard, and outputs this file to the primary storage unit 1308. A detailed method for implementing the DSM-CC is of no relation to the present invention, and therefore details are omitted.

An AM 1704b is an application manager that provides a function for managing the execution and termination of the Java program contained in the service. The AM 1704b extracts a Java program multiplexed into a channel specified by a specified MPEG-2 transport stream, and causes the execution or termination of that extracted Java program in accordance with separately-multiplexed synchronization information. A Java class file of the Java program is multiplexed into the MPEG-2 transport stream in the aforementioned DSM-CC format. In addition, the synchronization information of the Java program is in a format called AIT, and is multiplexed into the MPEG-2 transport stream. AIT is an acronym of Application Information Table, as defined in section 10 of the DVB-MHP specification (ETSITS 101812 DVB-MHP specification V1.0.2), and is an MPEG-2 section with a table_id of “0x74”.

FIG. 19 is a diagram showing a detailed configuration of the AM 1704b. The AM 1704b is configured of an AIT monitoring unit Z11 and an application status management unit Z12.

The AIT monitoring unit Z11 monitors the AIT update state using an MPEG-2 transport stream and a channel identifier as input, and if the AIT is updated, notifies the application status management unit Z12 of the updated AIT. First, the AM 1704b searches channel information in the library 1701b with a specified channel identifier as a key, and obtains the program number. Next, using the SF 1704e and the like, a PAT is acquired from the MPEG-2 transport stream. Then, the PID of a PMT that corresponds to the obtained program number is obtained from information of the PMT. Once again, using the SF 1704e, the actual PMT is acquired. The acquired PMT is in a format as shown in FIG. 11, and has written the PID of an elementary stream that has “data” as a stream identifier and “AIT” as supplemental information. Furthermore, when the PID and table_ID “0x74” of the AIT now obtained as the filtering conditions are given to the SF 1701e, the actual AIT is obtained.

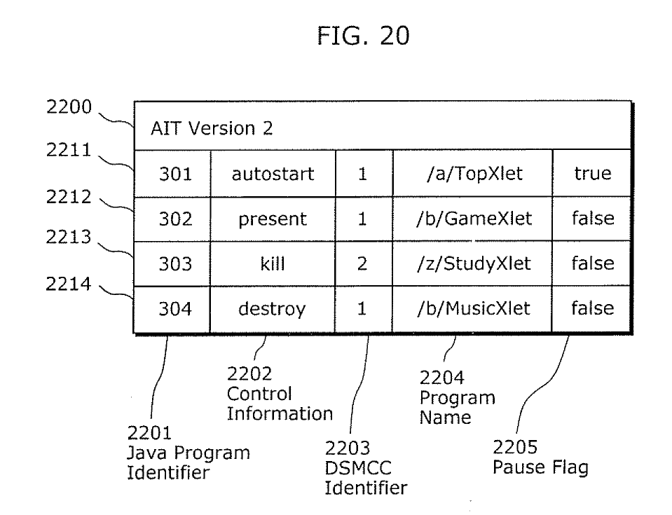

FIG. 20 is a chart that schematically shows an example of the AIT. An AIT version 2200 expresses the version of that AIT. The higher the version of the AIT, the newer the AIT is. AIT of the same version is repeatedly received, but the AM 1704b does not analyze AIT of a version identical to that of an AIT that has already been analyzed; rather, the AM 1704b analyzes only AIT newer than those already analyzed, and performs processing accordingly. Column 2201 is an identifier of the Java program. Column 2202 is control information of the Java program. In the control information, there is “autostart”, “present”, “kill”, and the like; “autostart” means that the terminal apparatus 1300 executes the Java program automatically and instantly, “present” means not performing automatic execution, and “kill” means stopping the Java program.

Column 2203 is a DSM-CC identifier for extracting the PID that includes the Java program in the DSM-CC format. Column 2204 is a program name of the Java program. Column 2205 is a pause flag that corresponds to each Java program. The pause flag is a flag that indicates whether or not the corresponding Java program is to be paused during trick play operation. The value “true” of the pause flag means that the corresponding Java program is paused in a trick play state, and then, when the trick play is canceled to return to a normal reproduction state, the execution of the paused Java program is resumed. The value “false” of the pause flag means that the corresponding Java program is continued to be executed without being paused even in a trick play state. In FIG. 20, as a Java program “/a/TopXlet” corresponding to a Java program identifier “301” has a pause flag value of “true”, the Java program is paused during trick play operation.

Rows 2211, 2212, 2213, and 2214 are groups of the information of the Java program. The Java program defined in the row 2211 indicates a group including a Java program identifier “301”, control information “autostart”, a DSM-CC identifier “1” a program name “a/TopXlet”, and a pause flag “true” Similarly, the Java program defined in the row 2212 is a group including a Java program identifier “302”, control information “present”, a DSM-CC identifier “1”, a program name “b/GameXlet”, and a pause flag “false”. Here, the three Java programs defined in the rows 2211, 2212, and 2214 have the same DSM-CC identifier. This indicates that three Java programs are included in one file system encoded in the DSM-CC format. Here, five types of information are prescribed for the Java program, but in reality, more types of information are defined. Refer to the DVB-MHP specification for details.

The application status management unit Z12 manages the execution status of the Java program through analyzing the details of the updated AIT received from the AIT monitoring unit Z11.

First, the operation of the application status management unit Z12 when the AIT is passed from the AIT monitoring unit Z11 shall be described hereinafter.

The application status management unit Z12 searches out a Java program with “autostart” within the AIT, and extracts the corresponding DSM-CC identifier and Java program name. Referring to FIG. 20, the application status management unit Z12 extracts the Java program from the row 2211 and acquires the DSM-CC identifier of “1” and the Java program name of “a/TopXlet”. Next, the application status management unit Z12 uses the DSM-CC identifier acquired from the AIT so as to acquire, from the PMT, the PID of the TS packet storing the Java program in the DSM-CC format. Specifically, the PID of the elementary stream with a conforming DSM-CC identifier in the supplementary information and which has a stream type of “data” is acquired from the PMT. Assuming here that the DSM-CC identifier is “1” and the PMT is as in FIG. 11, the elementary stream of the row 1114 conforms to the above elementary stream, and the PID “5014” is fetched.

The application status management unit Z12 prescribes, to the SF 1704e, the section filter conditions, and the PID of the TS packet which sends the MPEG-2 section embedded with data in the DSM-CC format. Here, a PID of 5014 is provided. As a result, the application status management unit Z12 reconstitutes the file system using the DSM-CC 1704d in accordance with the DSM-CC format, and saves the file system into the primary storage unit 1308. Fetching data such as the file system from the TS packet of the MPEG-2 transport stream and saving the data into a storage means such as the primary storage unit 1308 and the secondary storage unit 1307 is hereafter called “downloading”.

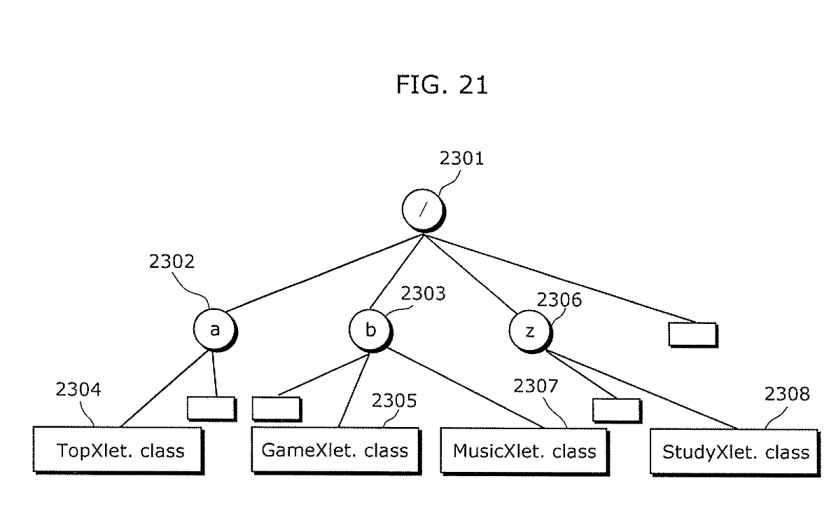

FIG. 21 is a diagram showing an example of a downloaded file system. In the diagram, a circle represents a directory and a square represents a file. 2301 is a root directory, 2302 is a directory “a”, 2303 is a directory “b”, 2304 is a file “TopXlet.class”, 2305 is a file “GameXlet.class”, 2306 is a directory “z”, 2307 is a file “MusicXlet.class”, and 2308 is a file “StudyXlet.class”.

Next, the application status managing unit Z12 passes the Java program to be executed to the Java VM 1703, from among the file systems downloaded to the primary storage unit 1308. Here, when the name of the Java program to be executed is “A/TopXlet”, the file “a/TopXlet.class”, in which “.class” is added to the end of the Java program name, is the file to be executed. “/” is a directory and file name division, and as can be seen in FIG. 21, the file 2304 is the Java program which should be executed. Next, the application status management unit Z12 passes the file 2304 to the Java VM 1703, and the file is executed, as a Java program, on the Java VM. In the case where “kill” is specified in the control information 2202, the Java program is terminated.

Each time AIT of a new version is acquired, the application status management unit Z12 analyzes that AIT and changes the execution status of the Java program.

A JMF 1704a handles control of reproduction of the video and audio contained in the service. To be more specific, the video ES and audio ES multiplexed into the specified channel of the specified MPEG-2 transport stream are inputted into the AV decoder and reproduced. In the case of reproducing the service directly from the received broadcast signal, an instruction is provided so that the MPEG-2 transport stream outputted from the adapter 1311 is reproduced. On the other hand, in the case of reproducing a service that has been recorded into the secondary storage unit 1307, an instruction is provided so that the MPEG-2 transport stream outputted from the recording area 1504 in the secondary storage unit 1307 is reproduced.

First, the JMF 1704a searches channel information in the library 1701b with a specified channel identifier as a key, and obtains the program number. Next, using the SF 1704e and the like, a PAT is acquired from the MPEG-2 transport stream. Then, the PID of a PMT that corresponds to the obtained program number is obtained from information of the PMT. Once again, using the SF 1704e, the actual PMT is acquired. The acquired PMT is in a format as shown in FIG. 11, and has written the PIDs of elementary streams that have “video” and “audio” as the stream identifiers. When the JMF 1704a sets these PIDs to the PID filter 1502 of the TS decoder 1302, the video ES and audio ES multiplexed with these PIDs are reproduced through the AV decoder 1303, as shown in FIG. 15 or FIG. 16.

Here, in the case where the JMF 1704a receives, as an input, an MPEG-2 transport stream which has already been recorded in the secondary storage unit, the JMF 1704a can change the reproduction speed of video and audio by changing the read speed and read position of the MPEG-2 transport stream from a storage area 1607 of the secondary storage unit 1307. Thus, trick play functions such as fast-forward and skip become possible. For example, in the case where the MPEG-2 transport stream is read out at a speed twice as fast as the normal speed, the video and audio are also reproduced twice as fast as the normal speed. In the case where a predetermined interval of the MPEG-2 transport stream is skipped and the MPEG-2 transport stream is read out from the readout position after the skip, the video and audio will be reproduced with such a skip occurring. By using the function of the library 1701b, the JMF 1704a controls the secondary storage unit 1307 and changes the readout speed and readout position of the MPEG-2 transport stream. The method of performing this trick play smoothly and at a high level deviates from the scope of the present invention, and therefore descriptions shall be omitted.

In order to instruct the Java program to perform trick play, the JMF 1704a provides, for example, a setRate (float factor) API to the lava program. When 1.0 is set for the “factor” parameter, reproduction is performed at normal speed, and when 2.0 is set for the “factor” parameter, trick play is performed with reproduction occurring at twice the normal speed. Furthermore, in the case where a lava program instructs trick play through an API, the JMF 1704a passes the reproduction speed before the instruction of the trick play and the reproduction speed after that instruction to the trick play start/stop determination unit of the trick play manager.

With the channel identifier, start time, and end time inputted, the recording manager 1704h records, in the secondary storage unit 1307, the period of time from the specified start time to the specified end time of the service. For example, when the channel identifier, start time, and end time are specified by the EPG 1702, the recording manager 1704h stands by until the start time. Then, when the start time is reached, the recording manager 1704h starts recording the specified service, and when the end time is reached, the recording manager 1704h terminates the recording. Details of this process shall be described below.

At the recording start time, the recording manager 1704h first secures, within the secondary storage unit 1307, a recording area 1504 for recording the MPEG-2 transport stream from the start time to the end time specified in the secondary storage unit 1307. A media identifier is supplied to the secured recording area. Next, with the channel identifier as a key, the recorded service selection unit 2404 obtains tuning information that corresponds to the channel identifier from channel information held by the library 1701b. After that, when the recorded service selection unit 2404 supplies the tuning information to the Tuner 1704c, the Tuner 1704c commences tuning. Here, the tuning information is information that can specify a frequency, a modulation type, and the like. Then, as shown in FIG. 15, the MPEG-2 transport stream is inputted into the TS decoder via the adapter 1311.

Meanwhile, using the SF 1704e, the recording manager 1704h acquires the PAT from the MPEG-2 transport stream obtained through the tuning. Furthermore, the recording manager 1704h searches the library 1701b to find out the program number corresponding to the specified channel identifier, and searches the PAT to find out the PID of the PMT corresponding to the obtained program number. After that, using the SF 1704e, it acquires the actual PMT so as to obtain all the PIDs of the ES which make up the specified channel. The recording manager 1704h sets the obtained PID in the PID filter 1502 of the TS decoder. After that, an output destination of each hardware constituent element is set through the library 1701b so as to follow the operation of recording the service included in the broadcast signal into the secondary storage unit 1307. Then, in accordance with the flow explained in FIG. 15, all ESs that make up a desired channel are recorded into the recording area 1504 that has been secured.

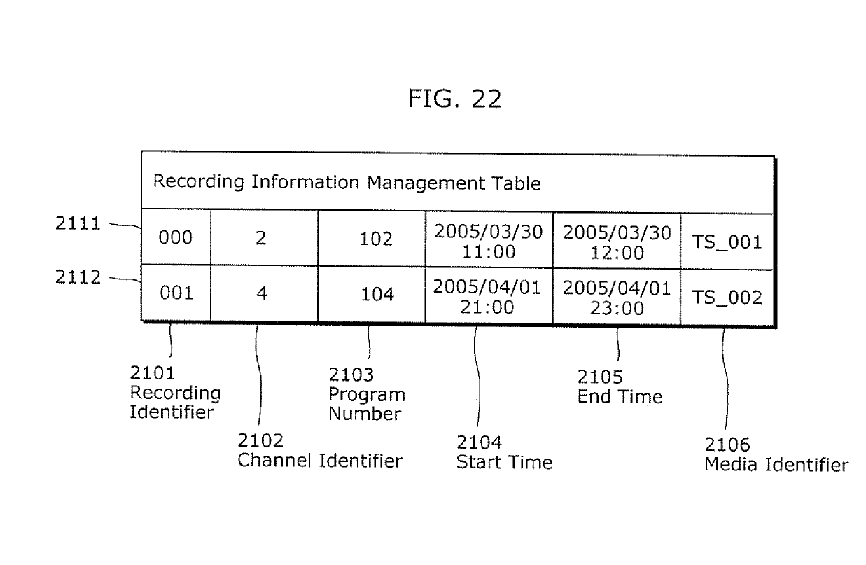

After that, when the specified end time is reached, the recording manager 1704h stops the tuning process of the Tuner 1704c, and causes the writing of the MPEG-2 transport stream into the recording area 1504 to end. In addition, a record information management table as shown in FIG. 22 is created as management information of the MPEG-2 transport stream recorded earlier.

FIG. 22 is a diagram showing an example of the record information management table for managing the record information recorded into the recording area 1504 of the secondary storage unit 1307 or the like. The record information management table is recorded in chart format. Column 2101 is a recording identifier. Column 2102 is a channel identifier. Column 2103 is a program number. Column 2104 is the record start time for the service, and column 2105 is the record end time for the service. Column 2106 is a media identifier that identifies the MPEG-2 transport stream that is recorded as the service. Each of rows 2111 to 2112 is a group of each recording identifier, channel identifier, program number, beginning time, ending time, and media identifier. For example, row 2111 shows a recording identifier of “000”, a channel identifier of “2”, a program number of “102”, a start time of “2005/03/30 11:00”, an end time of “2005/03/30 12:00”, and a media identifier of “TS_{—}001”.

A service manager 1704f manages reproduction of the service within the MPEG-2 transport stream that has been recorded into the secondary storage unit 1307, or the service within the MPEG-2 transport stream inputted from the adapter 1311.

Hereafter, a process performed when managing reproduction of the service contained in the MPEG-2 transport stream that has been recorded in the secondary storage unit 1307 shall be described. This is equivalent to reproduction of a recorded service. In this case, the service manager 1704f is inputted with the recording identifier. Only the service already recorded in the secondary storage unit 1307 and specified by that recording identifier is to be reproduced.

First, referring to the record information management table created by the recording manager 1704h, the service manager 1704f obtains the channel identifier and the media identifier to be reproduced, using the specified recording identifier Then, through is the library 1701b, the service manager 1704f instructs the secondary storage unit 1307 to output, to the TS decoder 1302, the MPEG-2 transport stream specified by the obtained media identifier. In addition, through the library 1701b, the service manager 1704f sets the output destination of each hardware constituent element to flow through the path shown in FIG. 16.

After that, the secondary storage unit 1307 is provided to the JMF 1704a as the location of the MPEG-2 transport stream, and the channel identifier of the channel to be reproduced is provided. Then, through the process described above, the JMF 1704a starts reproduction of the audio and video multiplexed into the MPEG-2 transport stream outputted from the secondary storage unit 1307. After that, the secondary storage unit 1307 is provided to the JMF 1704a as the location of the MPEG-2 transport stream, and the channel identifier to be reproduced is provided. Then, in accordance with the AIT multiplexed into the MPEG-2 transport stream outputted from the secondary storage unit 1307, the AM 1704b starts execution and termination of the Java program multiplexed into the MPEG-2 transport stream outputted from the secondary storage unit 1307. After that, reproduction of the service is continued until the end of the MPEG-2 transport stream outputted from the secondary storage unit 1307.

On the other hand, managing reproduction of the service within the MPEG-2 transport stream inputted from the adapter 1311 shall be described hereafter. This is corresponds to reproducing the service directly from the broadcast signal. In this case, the service manager 1704f has the channel identifier of the service to be reproduced as the input.

Through the library 1701b, the service manager 1704f instructs the MPEG-2 transport stream outputted from adapter 1311 of FIG. 15 to be outputted to the TS decoder 1302, In addition, through the library 1701b, the service manager 1704f sets the output destination of each hardware constituent element to flow through the path shown in FIG. 16. First, with the channel identifier as a key, the service manager 1704f obtains tuning information that corresponds to the channel identifier from channel information held by the library 1701b. After that, when the recorded service selection unit 2404 supplies the tuning information to the Tuner 1704c, the Tuner 1704c commences tuning. Here, the tuning information is information that can specify a frequency, a modulation method, and the like.

After that, the adapter 1311 is provided to the JMF 1704a as the location of the MPEG-2 transport stream, and the channel identifier to be reproduced is provided. Then, through the process described above, the JMF 1704a starts reproduction of the audio and video multiplexed within the MPEG-2 transport stream outputted from the adapter 1311. Furthermore, the adapter 1311 is provided to the AM 1704b as the location of the MPEG-2 transport stream, and the channel identifier of the channel to be reproduced is provided. Then, in accordance with the AIT multiplexed into the MPEG-2 transport stream outputted from the adapter 1311, the AM 1704b commences execution and termination of the Java program multiplexed into the MPEG-2 transport stream outputted from the secondary storage unit 1307. After that, reproduction of the service is continued until the end of the MPEG-2 transport stream outputted from the secondary storage unit 1307.

A description of a copy control manager 1704p shall be provided later.

The EPG 1702 is an Electric Program Guide, and is a function which lets a user choose a TV program to be recorded and reproduced. Normal reproduction through receiving a broadcast signal deviates from the scope of the present invention and thus descriptions shall be omitted.

In the case of recording the TV program, the EPG 1702 displays a list of broadcasted TV programs, and lets the user choose a desired TV program.

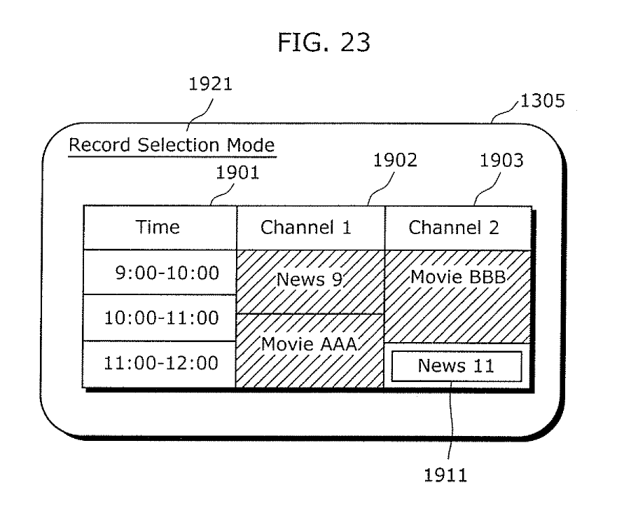

FIG. 23 is an example of a screen display for letting the user select a TV program to be recorded. A time 1901 and channels 1902 and 1903 are displayed in a grid, and it is possible to check the TV programs of each recordable channel at each time. It is possible for the user to move a focus 1911 around the screen by using up, down, right, and left cursor buttons 1401 to 1404, which are included in the input unit 1310 of the terminal apparatus 1300. Furthermore, when an OK button 1405 is pushed, the TV program which the focus currently highlights is selected to be recorded. The EPG 1702 acquires the channel identifier of the TV program from the library, and when the TV program to be recorded is selected by the user, notifies the channel identifier, start time, and end time of the TV program to the recording manager 1704h. Based on that information, the recording manager 1704h records the TV program into the secondary storage unit 1307.

On the other hand, in the case of reproducing an recorded TV program, the EPG 1702 displays a list of the recorded TV programs, and lets the user choose a desired TV program.

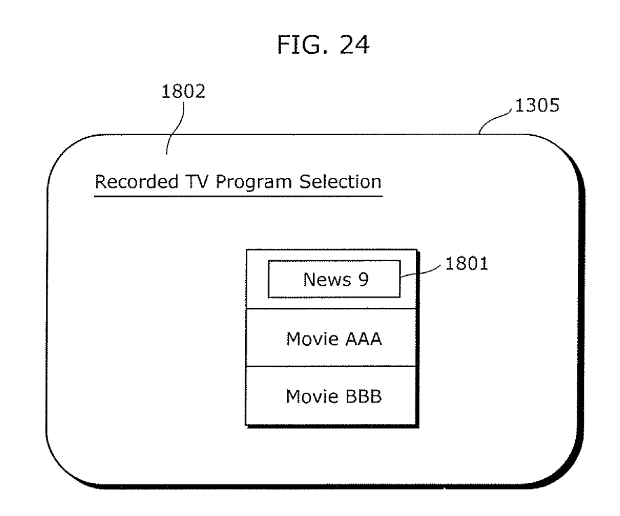

FIG. 24 is an example of a screen display for allowing selection of an recorded TV program. All TV programs stored in the secondary storage unit 1307 are listed. It is possible for the user to move a focus 1801 around the screen by using the top and bottom cursor buttons 1401 and 1402, which are included in the input unit 1310 of the terminal apparatus 1300. Furthermore, when the OK button 1405 is pushed, the TV program which the focus currently hits is selected to be reproduced. The EPG 1702 acquires the recording identifier of the TV program from recording manager 1704h, and when the TV program to be reproduced is selected by the user, notifies the service manager 1704f of the recording identifier of that TV program. Based on that information, the service manager 1704f reads out and reproduces the TV program from the secondary storage unit 1307.

Furthermore, in the case of copying a recorded TV program, the EPG 1702 displays a list of the recorded TV programs, and lets the user choose a desired TV program. When the user selects a TV program to copy and a copy destination, the “recording identifier” of the TV program and “copy destination” are notified to the copy control manager 1704p and the copy is requested.

Next, a description of the copy control manager 1704p shall be provided. Hereafter, for the sake of simplicity, a recorded service shall be called “recorded content”.

The copy control manager 1704p copies recorded content to the secondary storage unit 1307 of the terminal it belongs to (its own terminal) or other terminals. The recorded content includes: i) recorded content recorded by the recording manager 1704 of the terminal the copy control manager belongs to (its own terminal) into the recording area 1504 of the secondary storage unit 1307 of its own terminal; ii) recorded content recorded by the recording manager 1704 of another terminal into the recording area 1504 of the secondary storage unit 1307 of its own terminal; or iii) recorded content recorded by the recording manager 1704 of another terminal into the recording area 1504 of the secondary storage unit 1307 of another terminal.

Hereafter, the recording area 1504 of the terminal apparatus in which the recorded content is originally present shall be called the “copy source” and the recording area 1504 of the terminal apparatus to which the recorded content is copied shall be called the “copy destination”.

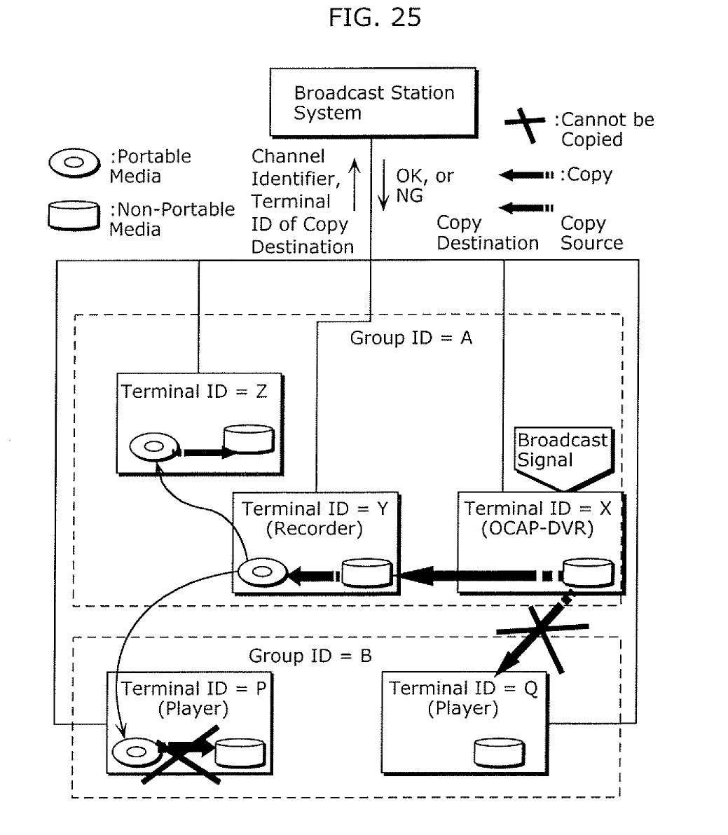

FIG. 25 is a diagram showing copying of recorded content being controlled by the content management system of the present embodiment. The present invention is applicable in both situations where the copy source and copy destination are present in the same terminal and situations where the copy source and copy destination are present in different terminals, as shown in FIG. 25.

The present invention is also applicable even in a terminal which does not feature a recording function, and has only a function for reproducing a recorded service. To be more specific, the present invention can be implemented even if the copy destination terminal does not include the tuner 1301 denoted in FIGS. 13 and 15 and the tuner 1704c denoted in FIG. 17, and is a terminal which reproduces, in accordance with the processing shown in FIG. 16, content recorded in the recording area 1504 by the copy manager 1704p.

In addition, the present invention is applicable even if the recording area 1504 of the copy source and copy destination is configured of a portable medium such as a DVD or a BD or is configured of a non-portable medium such as an HDD. In the case of recording into a portable recording medium such as a DVD or a BD, a drive device (not shown in the drawings) which reads from and writes to the portable medium is required by the terminal apparatus. This drive device may be included within the terminal apparatus itself, or may be an external device connected to the terminal apparatus.

In addition, the recording area 1504 of the recording destination is described as being included within the secondary storage unit 1307; however, the present invention is not limited thereto, and can be implemented even if the recording area 1504 is present in the primary storage unit 1308. Furthermore, the service manager 1704f, which is notified of the recording identifier may read out the TV program from the primary storage unit 1307 and reproduce the TV program. In such a case, the service manager 1704f reproduces the service within the MPEG-2 transport stream sent by a server and already recorded in the primary storage unit 1308 on the client side.

Hereafter, a process in the case of managing reproduction of the service contained in the MPEG-2 transport stream that has already been recorded in the secondary storage unit 1307 shall be described. This is equivalent to reproduction of a recorded service. In this case, the service manager 1704f has the recording identifier as an input. Only the service already recorded in the secondary storage unit 1307 and specified by that recording identifier is to be reproduced.

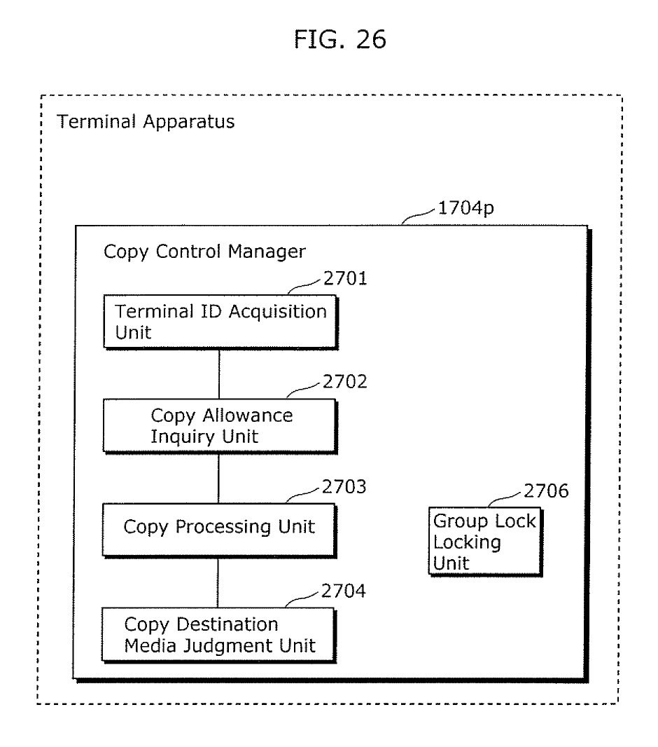

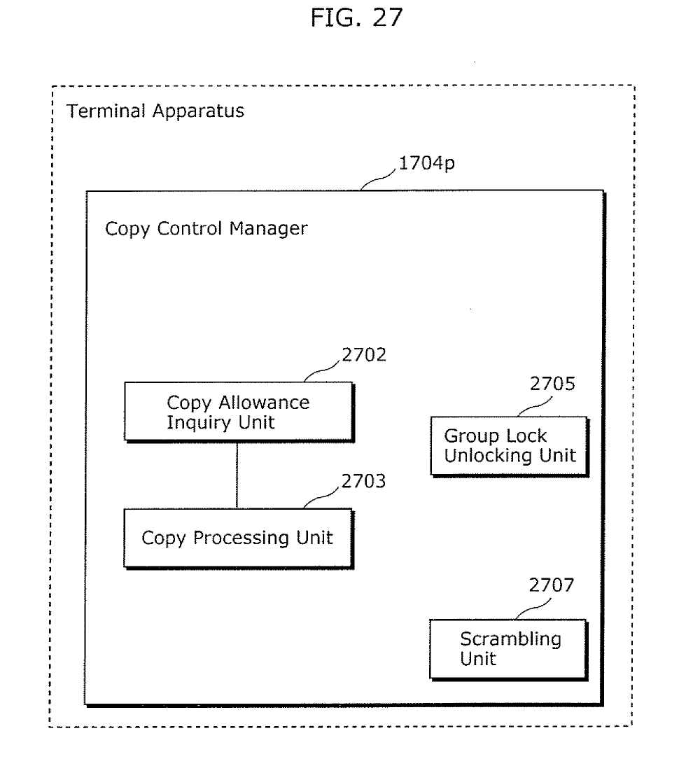

FIG. 26 and FIG. 27 are diagrams showing a detailed configuration of the copy control manager 1704p.

The copy control manager 1704p is present in the copy source terminal apparatus and the copy destination terminal apparatus. Hereafter, the copy source terminal apparatus shall be called the client terminal apparatus (client) and the copy destination terminal apparatus shall be called the server terminal apparatus (server).

In addition, the server and client are assumed as being connected to one another via, for example, a home network or the like. In this case, the terminal apparatuses corresponding to the server and client are each assumed as having a communications unit (not shown in the drawings) for sending/receiving information to one another via a Local Area Network (LAN) or the like.

FIG. 26 is a diagram showing a detailed configuration of the copy control manager 1704p on the client side.

FIG. 27 is a diagram showing a detailed configuration of the copy control manager 1704p on the server side.

The copy control manager 1704p on the client side passes the “recording identifier” and “copy destination” to the copy control manager 1704p on the server side, and requests copying of the recorded content.

The copy control manager 1704p on the client side is configured of a terminal ID acquisition unit 2701, a copy allowance inquiry unit 2702, a copy processing unit 2703, a copy destination media judgment unit 2704, and a group lock locking unit 2706.

The copy control manager 1704p on the server side is configured of a copy allowance inquiry unit 2702, a copy processing unit 2703, a group lock unlocking unit 2705, and a scrambling unit 2707.

Note that the present invention is applicable even without the copy destination media judgment unit 2704, the group lock locking unit 2706, the group lock unlocking unit 2705, and the scrambling unit 2705.

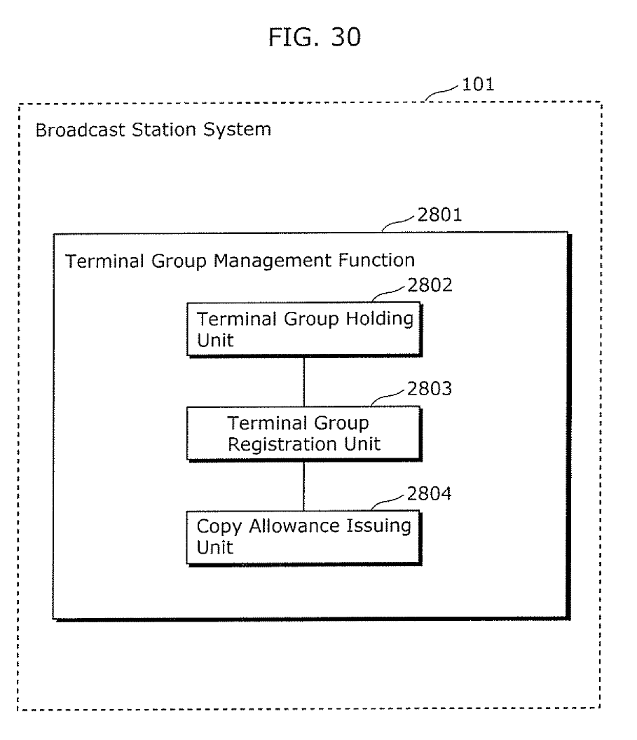

The terminal ID acquisition unit 2701 on the client side acquires the terminal ID of its own terminal. The terminal ID is a unique ID (identifier) that can identify the terminal via a terminal group management function 2801 (refer to FIG. 30) of the broadcast station system 101. The terminal ID may be an ID allocated to the terminal prior to shipping or an ID issued after shipping in response to a request from a subscriber who will view broadcasts; as long as the ID can uniquely identify the terminal, the present invention can be implemented.

The copy allowance inquiry unit 2702 on the client side passes, to the terminal group management function 2801 of the broadcast station system, the “terminal ID” of its own terminal and the “channel identifier”, thereby inquiring whether or not copying is allowed. Here, the copy allowance inquiry unit 2702 passes the “channel identifier” of the recorded content to be copied after referring to the recording information management table shown in FIG. 22, either by accessing the server and acquiring the identifier or by acquiring the identifier in advance. In addition, the inquiry to the terminal group management function 2801 may be performed using the previously described Out of Band (OOB) frequencies, or through another method (for example, using a communications line such as the Internet); the present invention can be implemented in either case. In the case where the terminal group management function 2801 provides “OK”, the copy allowance inquiry unit 2702 passes the “recording identifier” and “copy destination” to the copy processing unit 2703; and requests copying of the recorded content. On the other hand, in the case where the terminal group management function 2801 provides “NG”, the processing ends, with copying not being requested.

Meanwhile, the copy allowance inquiry unit 2702 on the server side passes, to the terminal group management function 2801 of the broadcast station system, the “terminal ID” of the client side and the “channel identifier”, and performs a copy allowance inquiry. Here, the copy allowance inquiry unit 2702 passes the “channel identifier” corresponding to the recording identifier of the recorded content to be copied after referring to the recording information management table shown in FIG. 22. In the case where the terminal group management function 2801 provides “OK”, and there is a terminal group lock on the recorded content, the copy allowance inquiry unit 2702 causes the group lock unlocking unit 2705 to release the terminal group lock from the recorded content passes the “recording identifier” and “copy destination” to the copy processing unit 2703, and requests that the recorded content be sent to the client side. On the other hand, in the case where the terminal group management function 2801 provides “NG” the processing finishes, without the copy allowance inquiry unit Y02 releasing the group lock and sending the request.

Here, locking the terminal group lock means rendering the recorded content unable to be re-copied, and releasing the terminal group lock means placing the recorded content in a state in which re-copying is possible. Any format may be used for the terminal group lock as long as it can set the re-copying to be possible/impossible. The terminal group lock format may be, for example, the Copy Control Information (CCI) format, which specifies “Copy Free”, “Copy Once”, “Copy No More”, and “Copy Never”.

The key that locks the terminal group lock and the key that releases the terminal group lock are keys allocated per terminal group, and are acquired from the broadcast station system and held from, for example, the terminal apparatus, when the terminal is installed or before processing for copying the recorded content is performed.

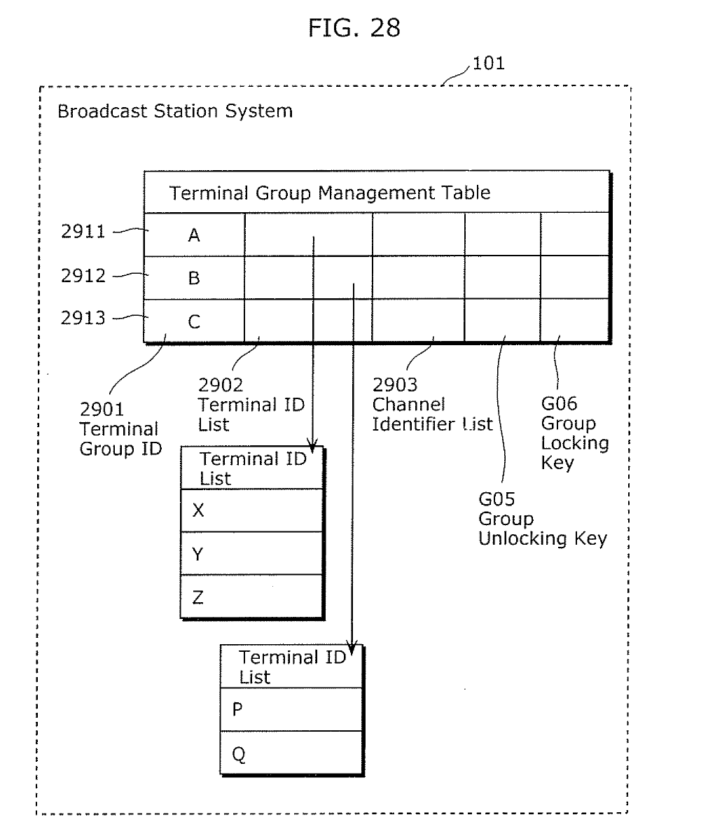

FIG. 28 is a diagram showing an example of a terminal group management table.

As shown in FIG. 28, the broadcast station system 101 holds a group unlocking key G05 and a group locking key G06, with which to lock and unlock the terminal group lock, in a terminal group management table. An explanation of “terminal group” shall be given later with description of the terminal group management function 2801. Note that the terminal group keys (the group unlocking key G05 and the group locking key G06) may be keys that are not acquired from the broadcast station, but rather are held in the terminal prior to that terminal being shipped; as long as it is a key that can release the terminal group lock only in the case where the copy allowance inquiry unit 2702 on the server side has obtained “OK” from the terminal group management function 2801, the present invention can be implemented.

Note also that keys generated by a terminal may be sent/received, shared between, and held by terminals belonging to the same group. Here, sharing of keys between terminals that belong to the same group may be carried out via the broadcast station.

In addition, it should be noted that the key that locks the terminal group lock and the key that releases the terminal group lock may be of a different format as long as it is a format that allows copying of content only between terminals that belong to the same group.

The group lock locking unit 2706 on the client side locks the terminal group lock on the received content, and renders the recorded content unable to be re-copied.

The group lock unlocking unit 2705 on the server side releases the terminal group lock on the recorded content to be copied, and places the recorded content in a state in which re-copying is possible.

The scrambling unit 2707 scrambles the recorded content. The definition of scrambling is as given earlier.

Upon being provided with the “recording identifier” and “copy destination”, the copy processing unit 2703 on the server side uses the scrambling unit 2707 and scrambles the recorded content specified by the recording identifier, sends the scrambled content to the copy processing unit 2703 on the client terminal that has the recording area specified by the “copy destination”, and requests copying. Note that the recorded content may be sent without being scrambled.

Upon being provided with the “recording identifier” and “copy destination”, the copy processing unit 2703 on the client side passes the “recording identifier”, the “copy destination”, and “terminal ID” to the copy control manager 1704p on the server side, and requests the content to be sent to the client side. When content is sent from the server side, the copy processing unit 2703 copies the content to the “copy destination”, and using the group lock locking unit 2706, locks the terminal group lock, rendering the recorded content copied to the copy destination unable to be re-copied. Then, the copied recorded content is added to the recording information management table.

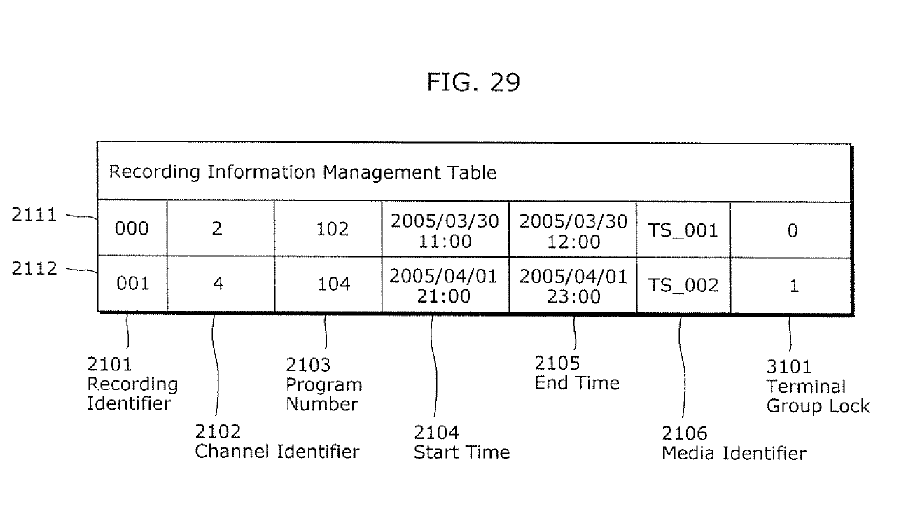

FIG. 29 shows the recording information management table, which includes the recorded content that has had the terminal group key locked and been recorded. Constituent elements in FIG. 29 that are identical to those in FIG. 22 are given the same numbers, and descriptions thereof shall be omitted. 3101 shows the terminal group lock setting for the recorded content. “0” indicates a state in which the group lock has been released, and “1” indicates a state in which the group lock has been locked.

Note that the copy processing unit 2703 on the client side may, for example, lock the terminal group lock, rendering re-copying of the recorded content specified by the recording identifier impossible, only in the case where the “copy destination” is a portable medium. In such a case, upon being provided with the “recording identifier” and “copy destination”, the copy processing unit 2703 on the client side requests the copy destination media judgment unit 2704 to judge whether the “copy destination” is a portable or non-portable medium. In the case where the “copy destination” is a portable medium, the copy processing unit 2703 locks the terminal group lock using the group lock locking unit 2706, rendering re-copying of the recorded content specified by the recording identifier impossible, and copies the recorded content to the “copy destination”. In the case where the “copy destination” is a non-portable medium, the copy processing unit 2703 copies the recorded content to the “copy destination” without locking the lock.

By using such a configuration, even if a user tries to copy recorded content that has been recorded onto a portable medium (or a storage medium) to a terminal apparatus that belongs to a different terminal group (to be described later), the terminal group lock is locked, and therefore copying is rendered impossible. However, if the terminal apparatus belongs to the same terminal group, copying is possible. Accordingly, from the viewpoint of the broadcast station, copying from terminal apparatuses that do not belong to the same terminal group is restricted, while from the viewpoint of the user, it is possible to perform copying within an allowed range (within the same terminal group).

Furthermore, it is acceptable for the copy processing unit is 2703 on the client side to not lock the recorded content specified by the recording identifier with the terminal group lock. In such a case, upon being passed the “recording identifier” and “copy destination”, the copy processing unit 2703 on the client side copies the recorded content specified by the recording identifier to the “copy destination”.

The copy destination media judgment unit 2704 on the client side judges whether the “copy destination” is a portable medium or a non-portable medium.

Next, descriptions shall be given regarding the terminal group management function 2801 of the broadcast station system 101. The terminal group management function 2801 issues “OK” or “NG” in response to an inquiry from the copy allowance inquiry unit 2702 on the terminal side.

FIG. 30 is a diagram showing a detailed configuration of the terminal group management function 2801 of the broadcast station system 101.

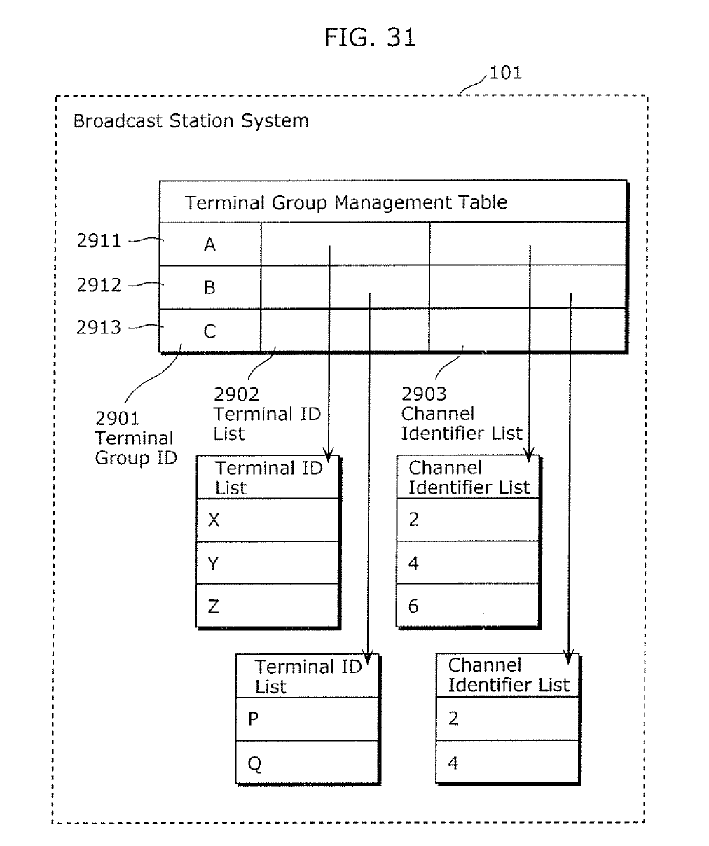

FIG. 31 is a diagram showing a terminal group management table.

A terminal group holding unit 2802 holds a terminal group management table, which is shown in FIG. 28 or FIG. 31. As shown in FIG. 31, 2901 is a group ID of the terminal group; 2902 is a terminal ID list of the terminals belonging to each terminal group; and 2903 is a list of channel identifiers of channels that belong to each terminal group. The terminal ID is, for example, an ID (identifier) allocated to each broadcast subscriber. In such a case, the terminal ID list has the ID of the terminal which the subscriber owns and which is registered with the broadcast station. In addition, in this case, the channel identifier list is a list of channels to which the subscriber is subscribed.

Note that the abovementioned FIG. 28 is an example of the terminal group management table held by the terminal group holding unit 2802 in the case where the group lock unlocking key and group locking key are acquired from the broadcast station system. In FIG. 28 and FIG. 31, identical constituent elements are given the same numbers. In addition, the group management table shown in FIG. 28 holds group lock unlocking keys G05, which belong to each terminal group, and group lock locking keys G06, which also belong to each terminal group.

A terminal group registration unit 2803 receives registrations of new terminal IDs to the terminal ID list for each terminal group ID and registrations of new channel identifiers to the channel identifier list, and updates the terminal group management table shown in FIG. 28 or FIG. 31. Any method of registering the new terminal IDs to the terminal ID list for each group and of registering new channel identifiers to the channel identifier list may be used.

Upon being passed the “terminal ID” and “channel identifier”, a copy allowance issuing unit 2804 refers to the terminal group management table shown in FIG. 28 and FIG. 31, and in the case where the “terminal ID” and “channel identifier” belong to the same group ID, returns “OK” to the inquirer; on the other hand, in the case where the “terminal ID” and “channel identifier” do not belong to the same group ID, the copy allowance issuing unit 2804 returns “NG” to the inquirer.

Note that only one of the copy allowance inquiry unit 2702 on the client side and the copy allowance inquiry unit 2702 on the server side may perform the copy allowance inquiry to the terminal group management function 2801 of the broadcast station system 101, rather than both the copy allowance inquiry unit 2702 on the client side and the copy allowance inquiry unit 2702 performing the inquiry. To be more specific, in the case where only the copy allowance inquiry unit 2702 on the server side performs the copy allowance inquiry to the terminal group management function 2801 of the broadcast station system 101, the copy allowance inquiry unit 2702 on the client side requests the copy processing unit 2703 to copy the recorded content, without performing the copy allowance inquiry to the terminal group management function 2801. On the other hand, in the case where only the copy allowance inquiry unit 2702 on the client side performs the copy allowance inquiry to the terminal group management function 2801 of the broadcast station system 101, the copy allowance inquiry unit 2702 on the server side requests the copy processing unit 2703 to send the recorded content to the client side, without performing the copy allowance inquiry to the terminal group management function 2801.

Note that the present invention is applicable even if the copy allowance inquiry to the terminal group management function 2801 of the broadcast station system 101 performed by the copy allowance inquiry unit 2702 on the client side is performed after the copy processing unit 2703 on the client side has had the content sent from the server side. In such a case, when the copy allowance inquiry unit 2702 on the server side has received “OK” from the terminal group management function 2801 and the terminal group lock on the recorded content is locked, the copy processing unit 2703 causes the terminal group lock on the recorded content to be released by the group lock unlocking unit 2705, and sends the recorded content to the client side. Then, the copy allowance inquiry unit 2702 on the client side performs the copy allowance inquiry to the terminal group management function 2801 of the broadcast station system 101 in the manner described earlier, and the copy processing unit 2703 on the client side copies the content to the “copy destination” only in the case where “OK” has been obtained.

Furthermore, the copy control manager 1704p on the server side may specify the client terminal apparatus from the server and send the content to that client side rather than copying the content after receiving a request from the client side. For example, the user operates the server terminal apparatus, and the EPG 1702 of the server terminal apparatus controls the copy control manager 1704p on the server side in accordance with the information inputted through the operation, thereby copying a recorded TV program to another terminal. In such a case, when the server side specifies the “copy destination” and sends the content, the copy processing unit 2703 on the client side copies the content to the “copy destination” and adds the content to the recording information management table, as described earlier.

Note that the server side that has been passed the “copy destination” from the client side may judge whether the “copy destination” is a portable or non-portable medium, and not send the content to the client side in the case where the copy destination is a portable medium.

It should also be noted that it is acceptable for the “copy destination” to not be passed to the copy control manager 1704p, the copy allowance inquiry unit 2702, and the copy processing unit 2703. In such a case, in the server side which has been requested by the client side to send the content, the copy processing unit 2703 on the server side sends the content to the copy processing unit 2703 on the client side without specifying the “copy destination”. Then, the copy processing unit 2703 on the client side, which has been sent the content, copies the content to the “copy destination”.

Finally, note that the copy control manager 1704p on the server side may include a terminal ID acquisition unit which acquires its own terminal ID. In such a case, the copy allowance inquiry unit 2702 uses the “terminal ID” of the server side acquired by the terminal ID acquisition unit and the “channel identifier” that corresponds to the recording identifier of the recorded content to be copied and performs the copy allowance inquiry.

A characteristic process in the present embodiment, which has the above-explained configuration, shall be described hereafter with reference to a flowchart.

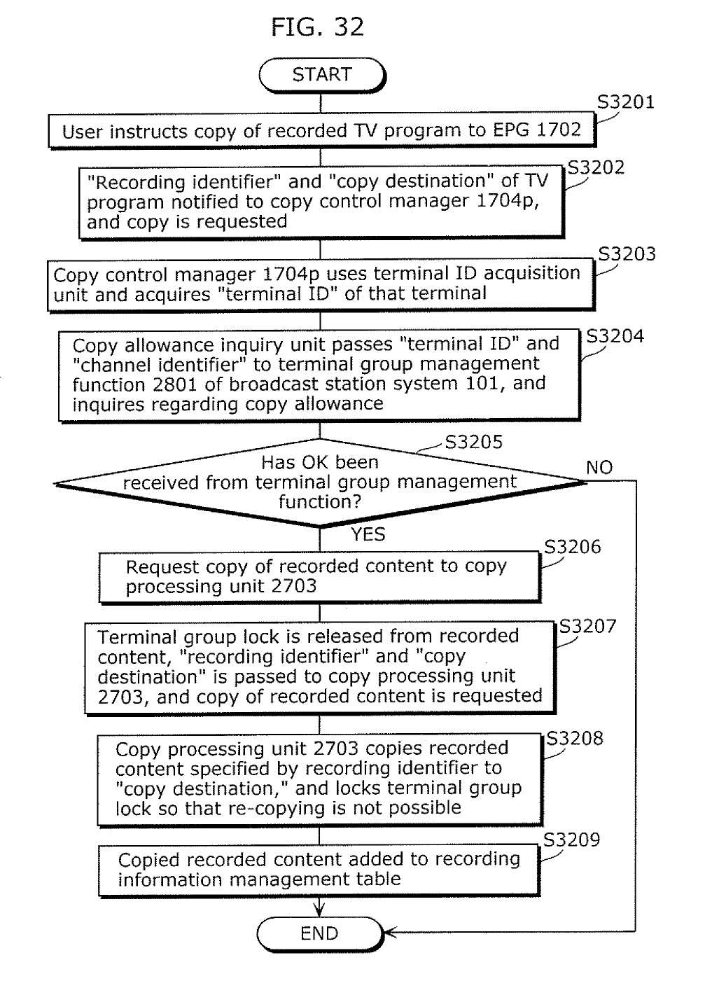

FIG. 32 is a flowchart showing processing on the client side in the case where recorded content stored in the “copy source” on the server side is copied to the “copy destination” on the client side.

First, the user provides an instruction via the EPG 1702 on the client side to copy a recorded TV program (S3201). As a result, the EPG 1702 notifies the “recording identifier” of the TV program and “copy destination” to the copy control manager 1704p, and the copy is requested (S3202). Next, upon being passed the “recording identifier” and “copy destination” and being requested to copy the recorded content, the copy control manager 1704p uses the terminal ID acquisition unit 2701 and acquires the “terminal ID” of the secondary storage unit present in the copy destination (S3203). Next, the copy allowance inquiry unit 2702 on the server side passes, to the terminal group management function 2801 of the broadcast station system, the “terminal ID” acquired by the terminal ID acquisition unit 2701, as well as passing the recording identifier and corresponding channel identifier of the recorded content to be copied after referring to the recording information management table shown in FIG. 22, thereby inquiring whether or not copying is allowed (S3204). In the case where the terminal group management function 2801 provides “OK” (YES in S3205), the copy allowance inquiry unit 2702 provides the “recording identifier” and “copy destination” to the copy processing unit 2703 and requests copying of the recorded content (S3206). On the other hand, in the case where the terminal group management function 2801 provides “NG” (NO of S3205), the copy allowance inquiry unit 2702 ends the processing without copying being requested.

Upon being passed the “recording identifier” and “copy destination” and requested to perform copying, the copy processing unit 2703 on the client side passes the “recording identifier” and “copy destination” to the copy control manager 1704p on the server side, and requests the content to be sent to the client side (S3207). When the content is sent, the copy processing unit 2703 copies it into the “copy destination”, and locks the terminal group lock, thereby preventing re-copying (S3208). Finally, the copy processing unit 2703 adds the copied recorded content to the recording information management table (S3209).

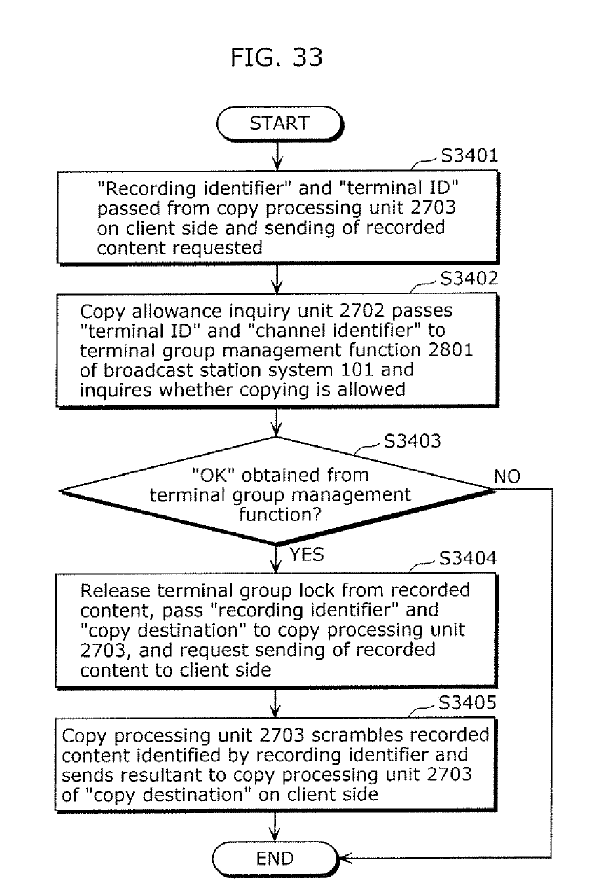

FIG. 33 is a flowchart showing processing on the server side in the case where recorded content stored in the secondary storage unit 1307 on the server side, which is the “copy source”, is copied into the secondary storage unit 1307 on the client side, which is the “copy destination”.

The copy control manager 1704p on the server side is passed the “recording identifier”, “copy destination”, and “terminal ID” from the copy processing unit 2703 on the client side, and is requested to send the recorded content (S3401). As a result, the copy allowance inquiry unit 2702 further passes, to the terminal group management function 2801 of the broadcast station system 101, the provided “terminal ID” as well as the recording identifier and corresponding channel identifier of the recorded content to be copied after referring to the recording information management table shown in FIG. 22, thereby inquiring whether or not copying is allowed (S3402). In the case where the terminal group management function 2801 provides “OK” (YES of S3403), and there is a terminal group lock on the recorded content, the copy allowance inquiry unit 2702 releases the terminal group lock from the recorded content, passes the “recording identifier” and “copy destination” to the copy processing unit 2703, and requests sending of the recorded content to the client side (S3404). On the other hand, in the case where the terminal group management function 2801 provides “NG” (S3403), the copy allowance inquiry unit 2702 finishes the processing without releasing the group lock and performing the send request.

Upon being passed the “recording identifier” and “copy destination”, the copy processing unit 2703 on the server side scrambles the recorded content specified by the recording identifier and sends the scrambled recorded content to the copy processing unit 2703 on the client side, which has the recording area specified by the “copy destination” (S3405).

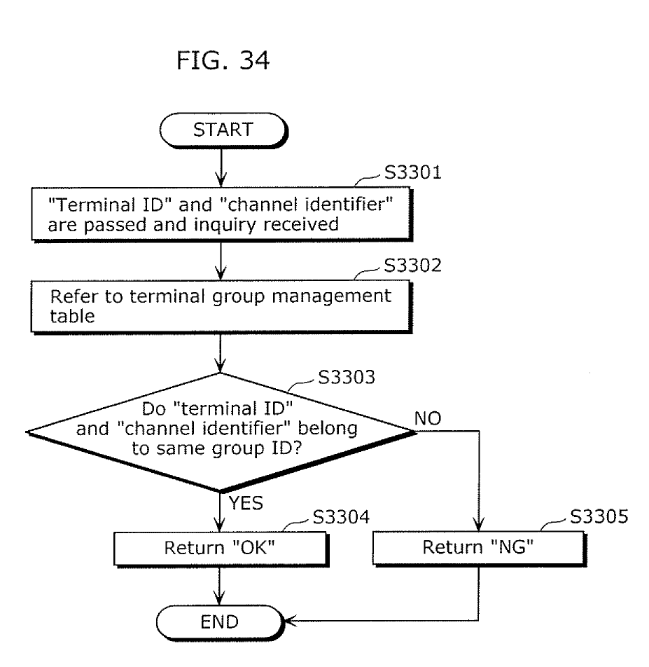

FIG. 34 is a flowchart for the case where the terminal group management function 2801 of the broadcast station system 101 is passed the “terminal ID” and “channel identifier” and issues either “OK” or “NG” in response to the inquiry from the copy allowance inquiry unit 2702 and the copy allowance inquiry unit 2702.

When the copy allowance issuing unit 2804 is passed the “terminal ID” and “channel identifier” and has received the inquiry (S3301), it refers to the terminal group management table shown in FIG. 28 or FIG. 31 (S3302). Then, in the case where the provided “terminal ID” and “channel identifier” belong to the same terminal group ID (YES of S3303), the copy allowance issuing unit 2804 returns “OK” to the inquirer (S3304). On the other hand, in the case where the provided “terminal ID” and “channel identifier” do not belong to the same group ID (NO of S3303), the copy allowance issuing unit 2804 returns “NG” to the inquirer (S3305).

As has been described above, by having a terminal apparatus perform an inquiry regarding copy allowance to the broadcast station system each time a copy is requested, the broadcast station can control copying in accordance with the newest terminal group management table available at the time of the copy request, even if the terminal group management table registered in the broadcast station system (terminal group ID, terminal ID lists, and channel identifier lists) has been updated. To be more specific, subscriber information managed by the broadcast station system (the terminal group management table) is updated in the case where the subscriber has registered a new terminal with the broadcast station, the case where a terminal registered up until that time has been cancelled, the case where the subscriber has subscribed to a new channel that can be copied between registered terminals, the case where a subscription to such a channel has been cancelled, and so on. It is possible for the broadcast station to continuously control the copying of content in accordance with the latest subscriber information (terminal group management table) even in cases such as these.

Moreover, as has been described above, a terminal group lock is locked for the content, thereby rendering the content unable to be re-copied; it is possible to copy content that has been copied to a portable medium in the case where both the copy source terminal and copy destination terminal have obtained copy allowance from the broadcast station system. To be more specific, content copied to a DVD is allowed to be re-copied (written back) only to terminal groups for which copy allowance for the content in question is obtained after inquiring with the broadcast station; on the other hand, re-copying to terminals for which copy allowance cannot be obtained after inquiring with the broadcast station, or to terminals which do not have a function for inquiring with the broadcast station, can be rendered impossible.

As has been described thus far, according to the first embodiment, it is possible to implement copying of recorded content restricted to a dynamic group of terminals which the user owns and which are registered with the broadcast station. In addition, a particularly noteworthy effect that can be achieved is that it is not possible to re-copy content to a recording medium in terminals that do not belong to the same terminal group, while it is possible to write back content to a recording medium in terminals that do belong to the same terminal group, when the content is being copied to a portable medium.

### Second Embodiment

In the first embodiment, when copying recorded content, by inquiring as to whether copying the recorded content is allowed with the terminal group management function 2804 of the broadcast station system 101, it is possible to implement copying of the recorded content restricted to a dynamic group of terminals which the user owns and which are registered with the broadcast station when copying the recorded content.

In the present embodiment, when reproducing recorded content, by inquiring as to whether reproducing the recorded content is allowed with the terminal group management function 2804 of the broadcast station system 101, it is possible to implement reproduction of the recorded content restricted to a dynamic group of terminals which the user owns and which are registered with the broadcast station when reproducing the recorded content.

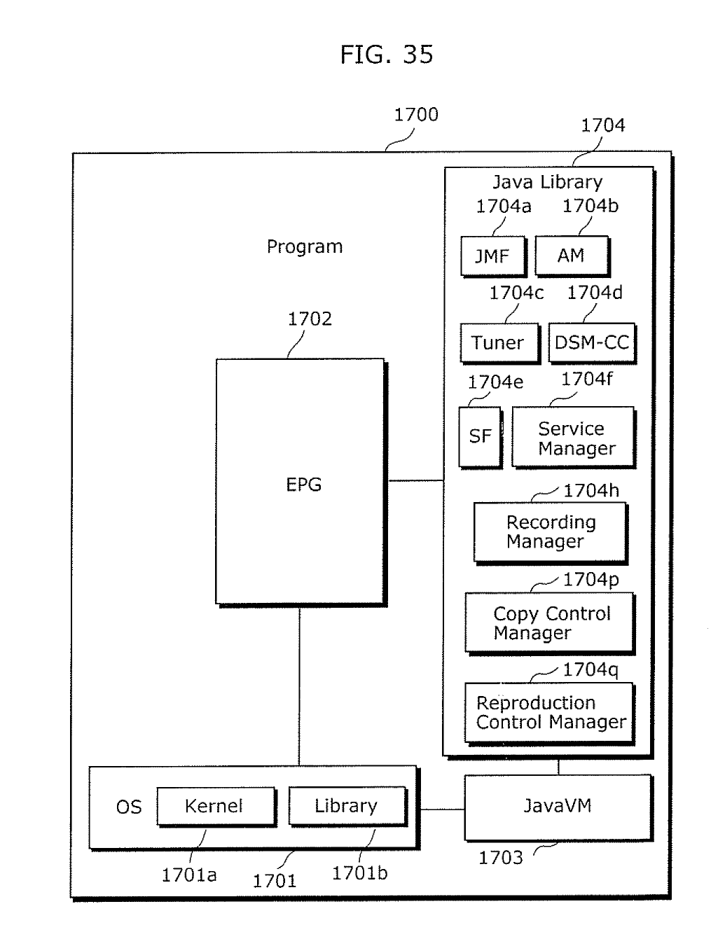

Hereafter, an apparatus and a method included in a content management system according to the second embodiment of the present invention shall be described with reference to the drawings (FIG. 35 to FIG. 39).

Note that since the overall hardware configuration and so on used in the second embodiment is the same as those in the first embodiment, FIG. 1 to FIG. 16 are used for the descriptions thereof. In addition, as the constituent elements in FIG. 35 to FIG. 39 have the same functions as the constituent elements with the same names and reference numbers as in the first embodiment, the same names and numbers as those used in the first embodiment shall be used here, and descriptions thereof shall not be repeated.

In addition, as various data formats used in the second embodiment are the same as those shown in FIG. 18, 20 to 22, 28, 29, and 31, descriptions thereof shall not be repeated.

FIG. 35 shows a software configuration of the second embodiment. In FIG. 35, because the constituent elements other than a reproduction control manager 1704q and the service manager 1704f are the same as the constituent elements in the software configuration of the first embodiment, descriptions thereof shall not be repeated.

In addition to the functions denoted in the first embodiment, the service manager 1704f includes the following functions.

When inputted with a recording identifier and requested to reproduce a service within an MPEG-2 transport stream already recorded in the secondary storage unit 1307, the service manager 1704f passes the “recording identifier” to the reproduction control manager 1704q, thereby requesting reproduction of the recorded service.

Hereafter, in the same manner as in the first embodiment, the service within the MPEG-2 transport stream already recorded in the secondary storage unit 1307 shall be referred to as “recorded content”.

The reproduction control manager 1704q controls the reproduction of i) recorded content recorded in the recording area 1504 within the secondary storage unit 1307 of its own terminal by the recording manager 1704 or the copy control manager 1704p of the terminal to which that reproduction control manager 1704q belongs (its own terminal), or ii) recorded content recorded in the recording area 1504 within the secondary storage unit 1307 of its own terminal by the copy control manager 1704p of another terminal.

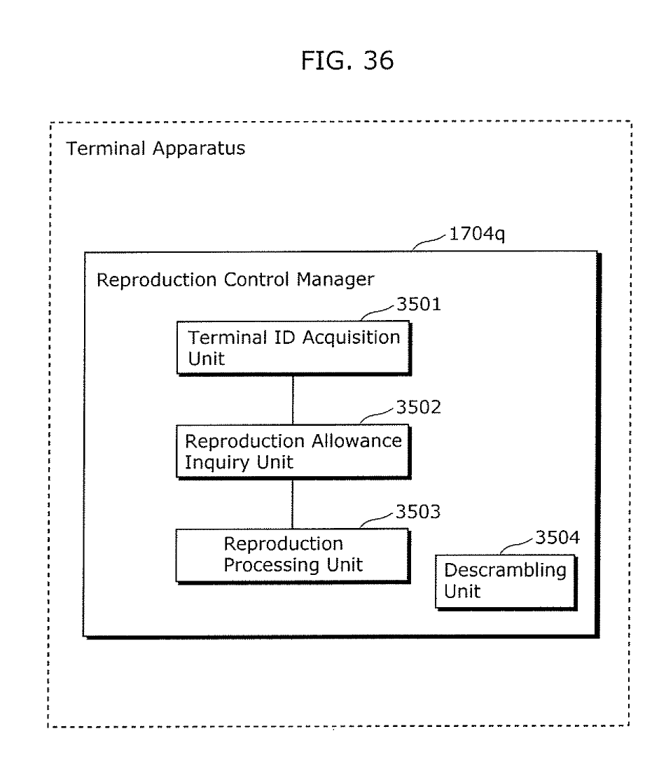

FIG. 36 is a diagram showing a detailed configuration of the reproduction control manager 1704q.

The reproduction control manager 1704q is passed the “recording identifier” and is requested to reproduce the recorded content. The reproduction control manager 1704q is configured of a terminal ID acquisition unit 3501, a reproduction allowance inquiry is unit 3502, a reproduction processing unit 3503, and a descrambling unit 3504.

Note that the present invention is still applicable even if the descrambling unit 3504 is not present.

The terminal ID acquisition unit 3501 acquires the terminal ID of the terminal apparatus to which that terminal ID acquisition unit 3501 belongs, or in other words, the terminal ID of its own terminal.

The terminal ID is a unique ID (identifier) that can identify the terminal via a terminal group management function 3601 of the broadcast station system 101. The terminal ID may be an ID allocated to the terminal prior to shipping or an ID issued after shipping in response to a request from a subscriber who will view broadcasts; as long as the ID can uniquely identify the terminal, the present invention can be implemented.

The reproduction allowance inquiry unit 3502 passes, to the terminal group management function 3601 of the broadcast station system, its own “terminal ID”, as well as the recording identifier and corresponding “channel identifier” of the recorded content to be reproduced after referring to the recording information management table shown in FIG. 22, thereby inquiring whether or not reproduction is allowed. In the case where the terminal group management function 3601 provides “OK”, the reproduction allowance inquiry unit 3502 provides the “recording identifier” to a reproduction processing unit 3503, and reproduction of the recorded content is requested. On the other hand, in the case where the terminal group management function 3601 provides “NG”, the reproduction allowance inquiry unit 3502 ends the processing without requesting reproduction.

Upon being provided with the “recording identifier” and being requested to reproduce the recorded content, the reproduction processing unit 3503 reproduces the recorded content up until the end of the MPEG-2 transport stream outputted from the secondary storage unit 1307, through processing identical to that performed in the case where the service manager 1704f is provided with the recording identifier and is requested to reproduce the service within the MPEG-2 transport stream already recorded in the secondary storage unit 1307, as indicated in the first embodiment.

In the case where the recorded content is scrambled, the reproduction allowance inquiry unit 3502 makes the reproduction request is to the reproduction processing unit 3503 after descrambling has been performed using the descrambling unit 3504.

Note that the present invention can also be implemented in the case where the recorded content has been scrambled and the reproduction processing unit 3503 uses the descrambling unit 3504 to perform descrambling.

The case where the recorded content is scrambled refers to, for example, the case indicated in the first embodiment where, in the processing for copying the recorded content, the server side sends scrambled recorded content to the client side, and the client copies the content.

The descrambling unit 3504 descrambles scrambled recorded content. The definition of “descrambling” is the same as that provided in the first embodiment.

A descrambling key may be acquired from the broadcast station system when the reproduction allowance inquiry unit 3502 has obtained “OK” from the terminal group management function 3601 of the broadcast station system. In such a case, the reproduction processing unit 3503 can reproduce the recorded content only when the descrambling key has been acquired.

In addition, the client may generate a pair of keys made up of a descrambling key and a scrambling key and pass the generated scrambling key to the server side via the broadcast station system during or before the copy processing indicated in the first embodiment. In such a case, the server side scrambles the recorded content with the scrambling key generated on the client side. After that, as the recorded content copied to the client side has been scrambled using the key generated by the client itself, the content can be descrambled using the descrambling key generated by the client itself, as it is the pair key.

In addition, the descrambling key may be acquired from the broadcast station system when “OK” has been obtained by the copy allowance issuing unit on the client side during the copy processing indicated in the first embodiment. In such a case, when the reproduction allowance inquiry unit 3502 has obtained “OK” from the terminal group management function 3601 of the broadcast station system, the recorded content is descrambled using the descrambling key already acquired, and reproduction is commenced.

Next, description shall be given regarding the terminal group management function 3601 of the broadcast station system 101 in the present embodiment. The terminal group management function 3601 issues “OK” or “NG” in response to an inquiry from the reproduction allowance inquiry unit 3502 on the terminal side.

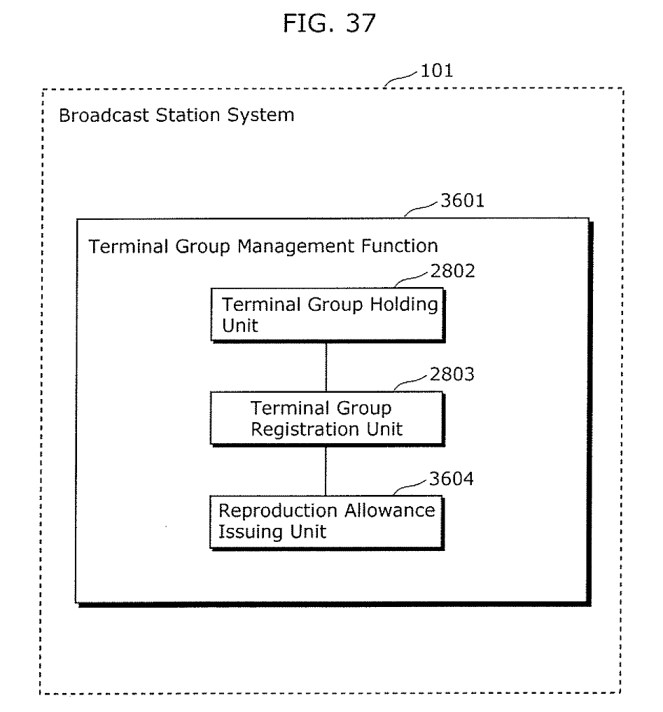

FIG. 37 is a diagram showing a detailed configuration of the terminal group management function 3601 of the broadcast station system 101 in the present embodiment. The constituent elements shown in FIG. 37 that are the same as the constituent elements shown in FIG. 30 shall be given the same names and the same reference numbers, and thus detailed descriptions shall not be repeated.

Upon being passed the “terminal ID” and “channel identifier”, the reproduction allowance issuing unit 3604 returns “OK” or “NG” to the inquirer, in the same manner as the copy allowance issuing unit 2804 of the first embodiment.

A characteristic process in the present embodiment that has the above-explained configuration shall be described below with reference to a flowchart.

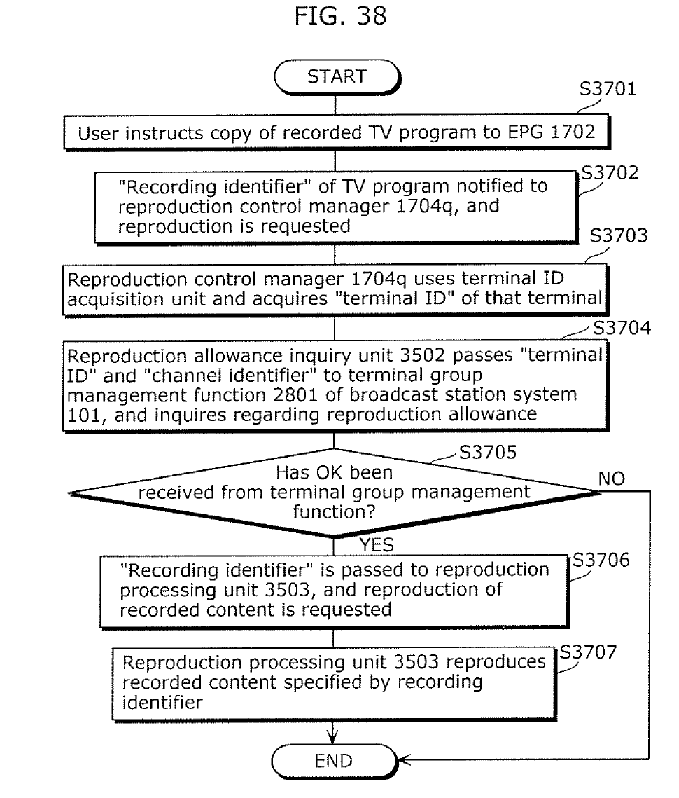

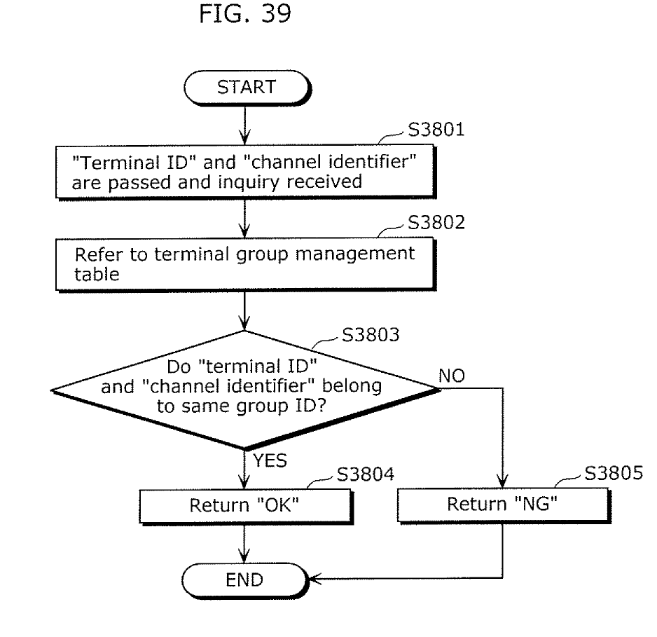

FIG. 38 is a flowchart showing the case where recorded content stored in the secondary storage unit of the copy source is reproduced.

First, the user provides an instruction via the EPG 1702 to reproduce a recorded TV program (S3701). As a result, the EPG 1702 notifies the “recording identifier” of that TV program to the reproduction control manager 1704q and requests reproduction (S3702). Next, upon being passed the “recording identifier” and being requested to reproduce the recorded content, the reproduction control manager 1704q uses the terminal ID acquisition unit 3501 and acquires the “terminal ID” of its own terminal (S3703). Continuing on, the reproduction allowance inquiry unit 3502 on the server side passes, to the terminal group management function 2801 of the broadcast station system, the “terminal ID” acquired by the terminal ID acquisition unit 3501, as well as the “channel identifier” that corresponds to the recording identifier of the recorded content to be reproduced after referring to the recording information management table shown in FIG. 22, thereby inquiring whether or not reproduction is allowed (S3704). In the case where “OK” has been obtained from the terminal group management function 2801 (YES of S3705), the reproduction allowance inquiry unit 3502 descrambles the recorded content in the case where it has been scrambled; the “recording identifier” is passed to the reproduction processing unit 3503, and reproduction of the recorded content is requested (S3706). On the other hand, in the case where the terminal group management function 2801 provides “NG” (NO of S3705), the reproduction allowance inquiry unit 3502 ends the processing without the recorded content and without requesting reproduction.

Upon being passed the “recording identifier” and being requested to perform reproduction, the reproduction processing unit 3503 reproduces the recorded content specified by the recording identifier (S3707).

FIG. 39 is a flowchart for the case where the terminal group management function 2801 of the broadcast station system 101 is passed the “terminal ID” and “channel identifier” and issues either “OK” or “NG” in response to the inquiry from the reproduction allowance inquiry unit 3502.

When the reproduction allowance issuing unit 3604 is passed the “terminal ID” and “channel identifier” and has received the inquiry (S3801), it refers to the terminal group management table shown in FIG. 28 or FIG. 31 (S3802). Then, in the case where the provided “terminal ID” and “channel identifier” belong to the same terminal group ID (S3803), the copy allowance issuing unit 2804 returns “OK” to the inquirer (S3804). On the other hand, in the case where the provided “terminal ID” and “channel identifier” do not belong to the same terminal group ID, the copy allowance issuing unit 2804 returns “NG” to the inquirer (S3805).

As has been described above, by the terminal apparatus performing an inquiry regarding reproduction allowance to the broadcast station system each time reproduction is requested, the broadcast station can control reproduction in accordance with the newest terminal group management table available at the time of the reproduction request, even if the terminal group management table registered in the broadcast station system (terminal group ID, terminal ID list, and channel identifier list) has been updated.

As has been described thus far, according to the second embodiment, it is possible to implement reproduction of recorded content restricted to a dynamic group of terminals which the user owns and which are registered with the broadcast station.

### Third Embodiment

In the present embodiment, information of terminals that can be connected to is acquired from the terminal group management function 2804 of the broadcast station system 101. When copying recorded content, the terminal copies the content only to terminals that can be connected to. Through this, it is possible to implement copying of the recorded content restricted to a dynamic group of terminals which the user owns and which are registered with the broadcast station when copying the recorded content.

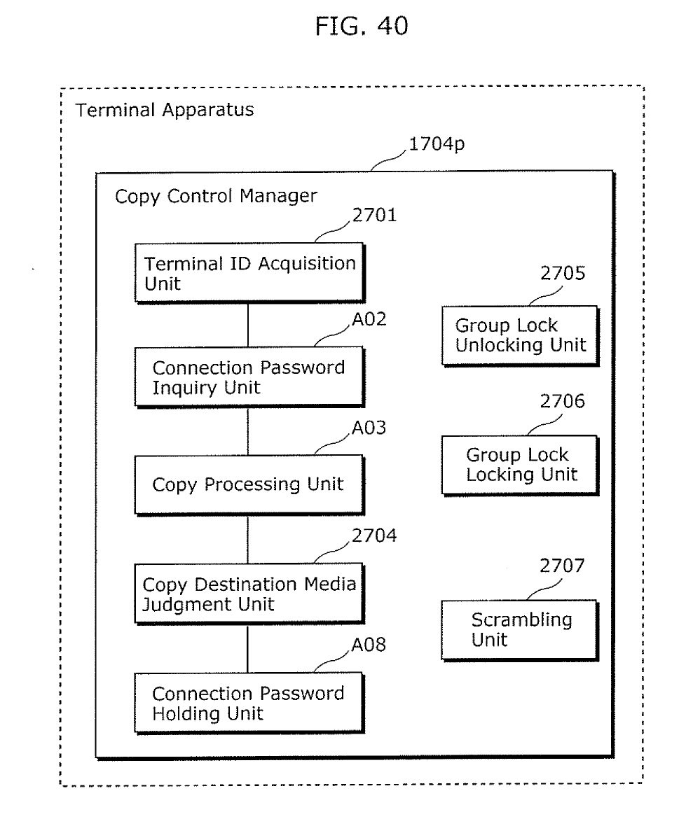

Hereafter, an apparatus and a method provided in the content management system according to the second embodiment of the present invention shall be described with reference to the drawings (FIG. 40 to FIG. 42).

Note that since the overall hardware configuration and so on used in the present third embodiment are same as those in the first embodiment of the present invention, FIG. 1 to FIG. 16 shall be used in the descriptions here. In addition, constituent elements shown in FIG. 40 to FIG. 42 that are identical to the constituent elements in the first embodiment shall be given the same names and reference numbers as in the first embodiment, and descriptions thereof shall not be given.

In addition, as various data formats used in the third embodiment are the same as those shown in FIG. 18, 20 to 22, 28, 29 and FIG. 31, and therefore descriptions thereof shall not be repeated.

Additionally, a software configuration of the present embodiment is identical to that shown in FIG. 17 in the first embodiment, with the exception of the processing function of the copy control manager 1704p

In addition, the copy control manager 1704p of the present embodiment copies recorded content stored in a recording area on the server side to a recording area on the client side.

FIG. 40 is a diagram showing a detailed configuration of the copy control manager 1704p according to the present embodiment. Constituent elements shown in FIG. 40 that are the same as those shown in FIG. 26 and FIG. 27 are given the same names and numbers as in FIG. 26 and FIG. 27, and descriptions thereof shall be omitted.

Note that the present invention is applicable even without the copy destination media judgment unit 2704, the group lock locking unit 2706, the group lock unlocking unit 2705, and the scrambling unit 2707.

The terminal ID acquisition unit 2701 acquires the terminal ID of the terminal to which the terminal ID acquisition unit 2701 belongs, or in other words, the terminal ID of its own terminal.

A copy processing unit A03 on the client side performs the same processing as the copy processing unit 2703 described in the first embodiment. Also, the copy processing unit A03 on the server side performs the same processing as the copy processing unit 2703 described in the first embodiment.

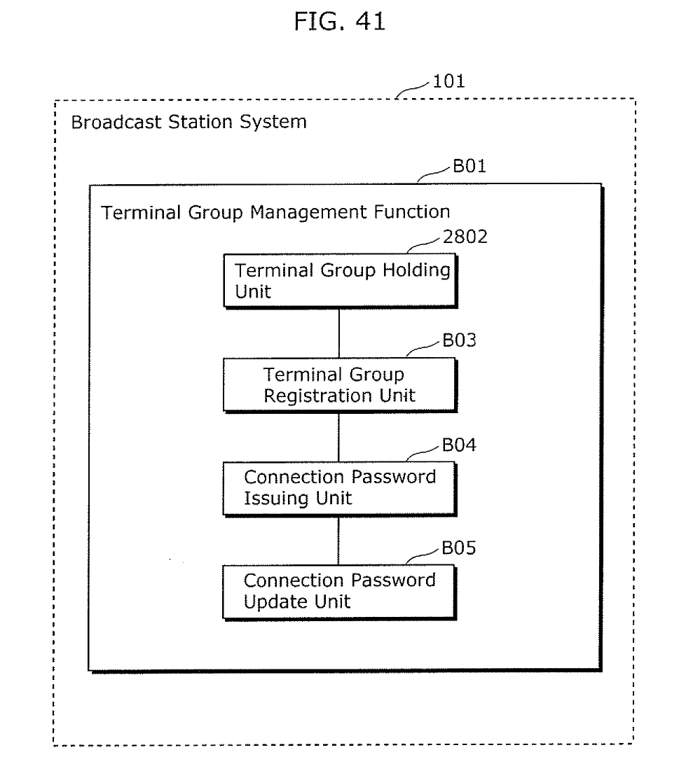

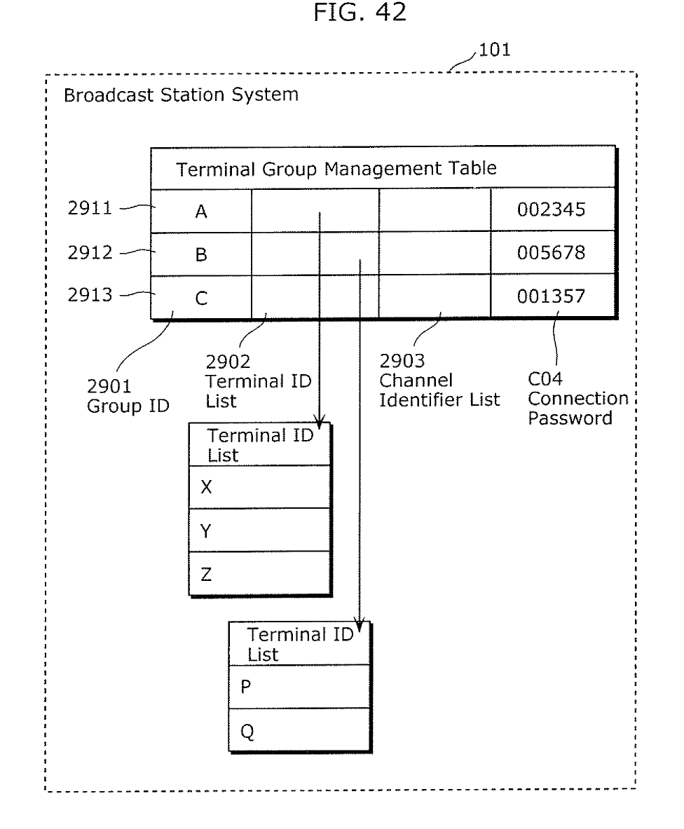

A connection password inquiry unit A02 passes its own “terminal ID” to a terminal group management function B01 (refer to FIG. 41) and performs an inquiry for a connection password.

Here, “connection password” refers to a password for communicating with a terminal; communications can be established and performed only between terminals that have the same password. In addition, “communications” specifically refers to the request to send the recorded content, the request being made by the client side to the server side, and the sending of the recorded content from the server side to the client side, as described in the first embodiment. Accordingly, it is possible for the recorded content stored in a recording area on the server side to be copied to a recording area on the client side only in the case where the server side and client side have the same connection password.

“Connection restriction via password” involves, for example, connection restriction via an SSID, which is used in the wireless LAN is IEEE 802.11 standard defined by the Institute of Electrical and Electronic Engineers (IEEE), connection restriction via a keyword as used in the coaxial cable-based c.LINK network technology promoted by the Multimedia over Coax Alliance (MoCA), and so on. However, note that any format is acceptable as long as it can implement the establishment of communications only between terminals that have the same connection password.

A connection password holding unit A08 holds, in the secondary storage unit or primary storage unit, the connection password acquired by the connection password inquiry unit A02.

Next, descriptions shall be given regarding the terminal group management function B01 of the broadcast station system 101.

FIG. 41 is a diagram showing a detailed configuration of the terminal group management function B01 of the broadcast station system 101. Constituent elements shown in FIG. 41 that are the same as those shown in FIG. 30 are given the same names and numbers as in FIG. 30, and therefore descriptions shall not be repeated.

FIG. 42 is example of the terminal group management table held by a terminal group holding unit B02. Constituent elements in FIG. 42 that are the same as those in FIG. 31 shall be given the same names and reference numbers, and thus detailed descriptions shall be omitted. C04 is the “connection password” of the terminal group. The “connection password” is a password allocated per terminal group, and is a password used when establishing communications between terminals belonging to the same terminal group. The connection password is updated by a connection password updating unit B05.

Upon being passed the “terminal ID” from the connection password inquiry unit A02 on the terminal side, a connection password issuing unit B04 receives an inquiry as to the connection password. Then, the connection password issuing unit B04 searches within the terminal group management table held by the terminal group holding unit B02, and returns the “connection password” associated with the terminal group belonging to the provided “terminal ID” to the inquirer. The connection password issuing unit B04 returns an error when there is no “connection password” associated with the terminal group that belongs to the provided “terminal ID”. Note that in the case where there is no “connection password” the connection password issuing unit B04 may perform a different processing as long as communications are not established with the inquiring terminal, rather than returning an error.

The connection password updating unit B05 updates the connection password. Updating of the connection is performed in the following situations: when a change occurs in the subscription details, such as when a new terminal is added to or an already-present terminal is deleted from the terminal group; when a password exceeds an expiration date; when a user applies for a password update via the Internet or the like; and so on.

A characteristic process in the present embodiment, which has the above-explained configuration, shall be described hereafter.

The inquiry for the connection password performed by the connection password inquiry unit A02 to the terminal group management function B01 of the broadcast station system and the holding of the connection password performed by the connection password holding unit A08 are performed before the copy control manager 1704p receives the copy request. When the copy control manager 1704p receives the copy request, the copy processing unit A03 refers to the connection password held by the terminal, and communications are established when the connection passwords on the client and server sides match; the recorded content stored in the recording area on the server side is then copied to the recording area on the client side. On the other hand, in the case where the passwords are different, communications are not established and the copy is not performed.

Variations on the timing at which the terminal on the client side and the terminal on the server side perform inquiry and holding of the connection password are shown below. The timing of the inquiry regarding the connection password may one of or a combination of several of 1 to 5 below:

1. When the terminal is installed.

2. When the subscriber who owns the terminal adds a new terminal to the subscription details held by the broadcast station, or cancels a subscription for an already-present terminal, and the connection password is updated; or when the broadcast station has specified that a password is to be updated.

3. When the expiration date of the connection password has been passed, in the case where the connection password has an expiration date.

4. When the terminal is turned on.

5. Every set interval.

Note that the present invention is applicable even if the inquiry and holding of the connection password is be performed at any step prior to the establishment of the connection between the client and server upon the copy control manager 1704p receiving the copy request.

### Fourth Embodiment

In the third embodiment, communications between the server and client are established using a connection password acquired from the broadcast station system. In the present embodiment, the broadcast station system is inquired regarding an “ID list of terminals to which a connection can be made” rather than a connection password, and the list is held, and communications between the server and client are established. In this case, it is possible for communications to be established between the server side and client side only when the terminal ID on the server side is written in the ID list of terminals to which a connection can be made that is held on the client side and the terminal ID of the client side is written in the ID list of terminals to which a connection can be made that is held on the server side. As a result, the recorded content stored in the recording area on the server side can be copied into the recording area on the client side.

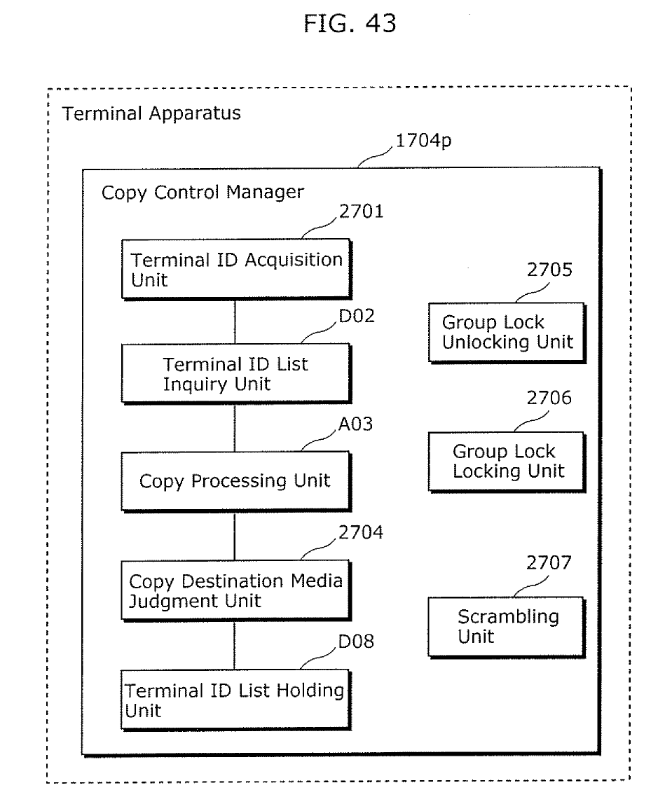

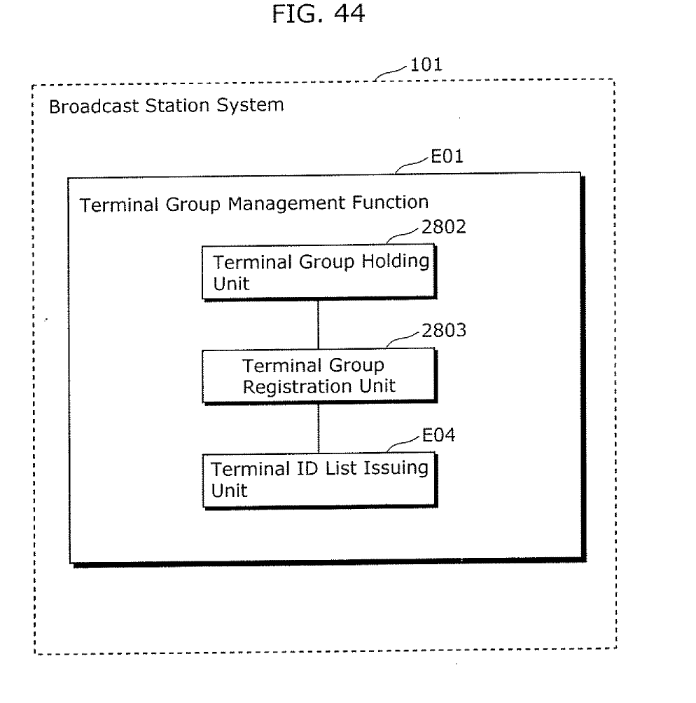

Hereafter, an apparatus and a method included in the content management system according to the present embodiment of the present invention shall be described with reference to the drawings (FIG. 43 and FIG. 44).

Note that since the overall hardware configuration and the like used in the fourth embodiment are same as those in the first embodiment of the present invention, FIG. 1 to FIG. 16 shall be used here for descriptions. In addition, the constituent elements shown in FIG. 43 and FIG. 44 that are the same as the constituent elements in the first embodiment shall be given the same names and reference numbers, and descriptions thereof shall be omitted.

In addition, as various data formats used in the fourth embodiment are the same as those shown in FIGS. 18, 20 to 22, 28, 29, and 31, descriptions thereof shall not be repeated. Furthermore, a software configuration of the present embodiment is identical to that shown in FIG. 17 in the first embodiment, with the exception of the processing function of the copy control manager 1704p.

The copy control manager 1704p of the present embodiment copies recorded content stored in a recording area on the server side to a recording area on the client side.

FIG. 43 is a diagram showing a detailed configuration of the copy control manager 1704p according to the present embodiment. Constituent elements shown in FIG. 43 that are the same as the constituent elements shown in FIG. 40 are given the same names and numbers as those in FIG. 40, and therefore descriptions shall be omitted.

A terminal ID list inquiry unit D02 passes the “terminal ID” of the terminal to which the terminal ID list inquiry unit D02 belongs, or in other words, its own “terminal ID” to a terminal group management function B01 and performs an inquiry for a “terminal ID list”.

Here, “terminal ID list” refers to a list of terminal IDs for terminals to which the terminal can connect to. It is possible for communications to be established between the server side and client side only when the terminal ID on the server side is written in the “terminal ID list” that is held on the client side and the terminal ID of the client side is written in the “terminal ID list” that is held on the server side. As a result, the recorded content stored in the recording area on the server side can be copied into the recording area on the client side.

The terminal ID list holding unit D08 holds the “terminal ID list” acquired by the terminal ID list inquiry unit D02 is the secondary storage area or the primary storage area.

Next, descriptions shall be given regarding a terminal group management function E01 of the broadcast station system 101.

FIG. 44 is a diagram showing a detailed configuration of the terminal group management function E01 of the broadcast station system 101. Constituent elements shown in FIG. 44 that are the same as constituent elements shown in FIG. 30 are given the same names and reference numbers as those of FIG. 30, and therefore descriptions shall be omitted.

A terminal ID list issuing unit E04 is passed the “terminal ID” from the terminal ID list inquiry unit D02 on the terminal side, and is inquired as to the ID list of terminals to which a connection can be made. As a result, the terminal ID list issuing unit E04 searches within the terminal group management table held by the terminal group holding unit 2802, and returns the “terminal ID list” that includes the provided “terminal ID” to the inquirer. An empty list is returned in the case where no “terminal ID list” that includes the provided “terminal ID” is provided. Note that in the case where there is no “terminal ID list”, the terminal ID list issuing unit E04 may perform a different processing rather than returning an empty list, as long as the processing does not establish communications are with the inquiring terminal.

A characteristic process of the present embodiment, which has the above-explained configuration, shall be described hereafter.

The inquiry for the “terminal ID list” performed by the terminal ID list inquiry unit D02 to the terminal group management function E01 of the broadcast station system and the holding of the “terminal ID list” performed by the terminal ID list holding unit D08 are performed before the copy control manager 1704p receives the copy request. When the copy control manager 1704p receives the copy request, the copy processing unit A03 refers to the “terminal ID list” held by the terminal, and after this, communications are established and the recorded content stored in the recording area on the server side is copied into the recording area on the client side in the case where the terminal ID of the server side is written in the “terminal ID list” that is held on the client side and the terminal ID of the client side is written in the “terminal ID list” that is held on the server side. On the other hand, in the case where the terminal ID of the server side is not written in the “terminal ID list” that is held on the client side and the terminal ID of the client side is not written in the “terminal ID list” that is held on the server side, communications are not established, and copying of the recorded content is not performed.

Variations on the timing at which the terminal on the client side and the terminal on the server side perform inquiry and holding of the “terminal ID list” are shown below. The timing of the inquiry regarding the “terminal ID list” may one of or a combination of several of 1 to 4 below:

1. When the terminal is installed.

2. When the subscriber who owns the terminal itself adds a new terminal to the subscription details held by the broadcast station, or cancels a subscription for an already-present terminal, and the “terminal ID list” is updated; or when the broadcast station has specified that a list is to be updated.

3. When the terminal is turned on.

4. Every set interval.

Note that the present invention is applicable even if the inquiry and holding of the “terminal ID list” is be performed at any step prior to the establishment of the connection between the client and server upon the copy control manager 1704p receiving the copy request.

The first through the fourth embodiments described above indicate exemplary embodiments of the present invention, but other embodiments can be considered without deviating from the scope of the present invention.

For example, in the first through fourth embodiments, the content sent from the server side is recorded into the secondary storage unit on the client side, but the content may be reproduced without being recorded into the secondary storage unit on the client side. Specifically, the client side inputs, either directly or after temporary storage in the primary storage unit, the content sent from the server side into the AV decoder.

Furthermore, in the first through the fourth embodiments, a configuration for a cable system has been shown, but the present invention can be applied independent of the type of broadcast system. For example, the present invention can easily be applied to a satellite system, a ground wave system, or a TV program distribution system that uses an IP network. In addition, as the present invention has no direct relationship with the differences between each broadcast system, the present invention can be applied to an arbitrary transmission medium regardless of the broadcast system. The present invention is also applicable regardless of whether the system is a wired or wireless system.

Moreover, it is not necessary for the AV decoder to decode video and audio at the same time. The present invention can be implemented even if the AV decoder is configured as separate video and audio decoders. In addition, the AV decoder may have a decode function for data such as closed captioning and the like. The audio signal and video signal decoded by the AV decoder may be encrypted at any stage up until being stored in the recording area 1504.

In addition, in the first through the fourth embodiments, an example is given in which an adapter that controls limited viewing has been introduced, but the adapter is not necessary for the implementation of the present invention. The adapter may be of any format, and a configuration without the adapter is also possible. In such a case, in FIG. 15, the MPEG-2 transport stream from the tuner 1301 is inputted directly into the TS decoder 1302. The present invention is applicable is such a case as well. In addition, removal of the limited viewing by the adapter does not necessarily have to be carried out before the TS decoder. A configuration in which the adapter is in an arbitrary position and is used to remove the limited viewing is easily implementable, and the present invention is applicable in such a case as well.

Moreover, regarding an encoding format into which the AV encoder encodes the audio and video signal, an arbitrary format is acceptable. The present invention is applicable regardless of the encoding format.

In addition, a multiplexing format of the multiplexer may also be an arbitrary format. The present invention is applicable regardless of the multiplexing format.

Furthermore, the display and the speaker may be contained within the broadcast recording and reproduction apparatus, or an external display and speaker may be connected to the broadcast recording and reproduction apparatus. The present invention is applicable regardless of the location and number of the display and speaker.

Also, the present invention can be implemented even if the CPU itself is a system which performs multiple processes, the processes being all or some of TS decoding, AV decoding, AV encoding, and multiplexing.

As a format for recording the service, the MPEG-2 transport stream can also be recorded directly into the recording area after being outputted from the tuner, without going through the TS decoder; or, the format of the MPEG-2 transport stream from the tuner can be converted, by installing a translator that converts the format of the MPEG-2 transport stream, and recorded into the recording area. The present invention can be implemented regardless of the service recording method.

Some of the Java virtual machines translate the bytecode into an executable form which can be interpreted by the CPU, and pass the resultant to the CPU which executes it; the present invention is applicable in such case as well.

In addition, the above first through fourth embodiments describe a method for implementation regarding the AIT in which the transport stream is obtained from in-band; however, the method for referring to the Java program which the AM shall execute does not solely depend on the AIT. In OCAP, which is assumed to be used by the United States cable system, an XAIT, which has registered reference information of a Java program in the OOB denoted in FIG. 3, is used. In addition, methods such as starting a program pre-recorded in the ROM, starting a program downloaded and recorded in the secondary storage unit, and so on can be considered.

In this manner, according to the content recording and reproduction apparatus and content recording and reproduction method of the content management system of the present invention, it is possible to perform copying/reproduction of content limited to a fluctuating group of devices which the user holds and for which copying/reproduction is authorized by the broadcast station. In addition, when copying content to a portable medium such as a DVD, it is possible to allow re-copying to devices which the user holds and for which copying/reproduction is authorized by the broadcast station, and to prohibit re-copying to other devices.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The content management system according to the present invention has the effect of making it possible to increase the degree of freedom with which a broadcast station manages content, and is applicable in, for example, a cable set-top box (STB), a digital television, or the like.

What is claimed is:

1. A content management system comprising:
a server terminal apparatus that holds, as recorded content, content broadcasted from a broadcast station apparatus; and
a client terminal apparatus that requests the recorded content from said server terminal apparatus,
wherein said server terminal apparatus includes:
a content storage unit operable to store content broadcasted over a channel in association with an identifier of the channel as the recorded content; and
a first processing unit operable to receive a request to transfer the recorded content stored in said content storage unit, and to transfer the recorded content, and
wherein said client terminal apparatus includes:
a terminal information holding unit which holds terminal identification information for identifying said client terminal apparatus;
an inquiry unit operable to inquire with the broadcast station apparatus as to whether or not transfer of the recorded content stored in said content storage unit of said server terminal apparatus is permitted; and
a second processing unit operable to request said server terminal apparatus to transfer the recorded content in the case where the transfer is permitted by the broadcast station apparatus, and to store the transferred recorded content in a storage medium.

2. The content management system according to claim 1, further comprising
the broadcast station apparatus,
wherein said broadcast station apparatus includes:
a table holding unit which holds a terminal group management table including: a terminal identification list for identifying a terminal for which the transfer is permitted; a channel identifier list including channel identifiers of channels viewable via a terminal associated with terminal identification information present in the terminal identification list; and terminal group identification information which identifies the terminal identification list and the channel identifier list; and
a permission issuing unit operable to issue permission for the transfer in response to the request from said client terminal apparatus, and
wherein said inquiry unit of said client terminal apparatus is operable to send the channel identifier of the recorded content and the terminal identification information to said broadcast station apparatus along with performing the inquiry, and
said permission issuing unit is operable to refer to the terminal group management table held by said table holding unit, and issue permission for the transfer to said client terminal apparatus in the case where the terminal identification list, which includes the terminal identification information, and the channel identifier list, which includes the channel identifier, are specified by the same terminal group identification information.

3. The content management system according to claim 2,
wherein said broadcast station apparatus further holds group lock locking information which is associated with the terminal group identification information;
said client terminal apparatus further includes
a group lock locking unit operable to acquire, from said broadcast station apparatus, the group lock locking information corresponding to the terminal group identification information that identifies the terminal identification list including the terminal identification information held by said client terminal apparatus, to hold the group lock locking information, and to set a restriction on copying of the recorded content using the held group lock locking information; and
said group lock locking unit is operable to set the restriction on copying of the recorded content using the group lock locking information after the recorded content has been stored in the storage medium.

4. The content management system according to claim 3,
wherein said client terminal apparatus further includes
a judgment unit operable to judge whether or not the storage medium is a portable storage medium; and
in the case where the storage medium is judged by said judgment unit to be a portable storage medium, said group lock locking unit is operable to set the restriction on copying of the recorded content using the group lock locking information after the recorded content has been stored in the portable storage medium.

5. The content management system according to claim 4,
wherein said broadcast station apparatus further holds group lock unlocking information which is associated with the terminal group identification information; and
said client terminal apparatus further includes
a group lock unlocking unit operable to acquire, from said broadcast station apparatus, the group lock unlocking information corresponding to the terminal group identification information that identifies the terminal identification list including the terminal identification information held by said client terminal apparatus, to hold the group lock unlocking information, and to release the restriction on copying of the recorded content stored in the portable storage medium using the group lock unlocking information acquired from said broadcast station apparatus.

6. A content management system comprising:
a server terminal apparatus that holds, as recorded content, content broadcasted from a broadcast station apparatus; and
a client terminal apparatus that requests the recorded content from said server terminal apparatus,
wherein said server terminal apparatus includes:
a content storage unit operable to store content broadcasted over a predetermined channel in association with an identifier of the predetermined channel as the recorded content;
a server inquiry unit operable to receive a request to transfer the recorded content stored in said content storage unit, and to inquire with the broadcast station apparatus as to whether or not transfer of the recorded content is permitted; and
a first processing unit operable to transfer the recorded content to a transfer destination in the case where the transfer is permitted by the broadcast station apparatus, and
wherein said client terminal apparatus includes
a second processing unit operable to request said server terminal apparatus to transfer the recorded content and to store the transferred recorded content in a storage medium.

7. The content management system according to claim 6, further comprising
the broadcast station apparatus,
wherein said broadcast station apparatus includes:
a table holding unit which holds a terminal group management table including: a terminal identification list for identifying a terminal for which the transfer is permitted; a channel identifier list including channel identifiers of channels viewable via a terminal associated with terminal identification information present in the terminal identification list; and terminal group identification information which identifies the terminal identification list and the channel identifier list; and
a permission issuing unit operable to issue permission for the transfer in response to the request from said client terminal apparatus, and
wherein said client terminal apparatus is operable to send the terminal identification information of said client terminal apparatus to said server terminal apparatus along with requesting said server terminal apparatus to transfer the recorded content;
said server inquiry unit is operable to send the channel identifier of the recorded content and the terminal identification information of said client terminal apparatus to said broadcast station apparatus along with performing the inquiry, and
said permission issuing unit is operable to refer to the terminal group management table held by said table holding unit, and issue permission for the transfer to said client terminal apparatus in the case where the terminal identification list, which includes the terminal identification information, and the channel identifier list, which includes the channel identifier, are specified by the same terminal group identification information.

8. The content management system according to claim 7,
wherein said client terminal apparatus further includes:
a terminal information holding unit which holds terminal identification information for identifying said client terminal apparatus; and
a client inquiry unit operable to inquire with said broadcast station apparatus as to whether or not transfer of the recorded content stored in said content storage unit of said server terminal apparatus is permitted, and
said second processing unit is operable to request said server terminal apparatus to transfer the recorded content in the case where the transfer is permitted by said broadcast station apparatus in response to the inquiry made by said client inquiry unit, and to store the transferred recorded content in the storage medium.

9. The content management system according to claim 8,
wherein said client inquiry unit is operable to send the channel identifier of the recorded content and the terminal identification information of said client terminal apparatus to said broadcast station apparatus along with performing the inquiry, and
said permission issuing unit is operable to refer to the terminal group management table held by said table holding unit, and issue permission for the transfer to said client terminal apparatus in the case where the terminal identification list, which includes the terminal identification information, and the channel identifier list, which includes the channel identifier, are specified by the same terminal group identification information.

10. The content management system according to claim 7,
wherein said broadcast station apparatus further holds group lock locking information which is associated with the terminal group identification information;
said client terminal apparatus further includes
a group lock locking unit operable to acquire, from said broadcast station apparatus, the group lock locking information corresponding to the terminal group identification information that identifies the terminal identification list including the terminal identification information held by said client terminal apparatus, to hold the group lock locking information, and to set a restriction on copying of the recorded content using the held group lock locking information; and
said group lock locking unit is operable to set the restriction on copying of the recorded content using the group lock locking information after the recorded content has been stored in the storage medium.

11. The content management system according to claim 10,
wherein said client terminal apparatus further includes
a judgment unit operable to judge whether or not the storage medium is a portable storage medium, and
in the case where the storage medium is judged by said judgment unit to be a portable storage medium, said group lock locking unit is operable to set the restriction on copying of the recorded content using the group lock locking information after the recorded content has been stored in the portable storage medium.

12. The content management system according to claim 11,
wherein said broadcast station apparatus further holds group lock unlocking information which is associated with the terminal group identification information; and
said client terminal apparatus further includes
a group lock unlocking unit operable to acquire, from said broadcast station apparatus, the group lock unlocking information corresponding to the terminal group identification information that identifies the terminal identification list including the terminal identification information held by said client terminal apparatus, to hold the group lock unlocking information, and to release the restriction on copying of the recorded content stored in the portable storage medium using the group lock unlocking information acquired from said broadcast station apparatus.

13. A content management system comprising:
a server terminal apparatus that holds, as recorded content, content broadcasted from a broadcast station apparatus; and
a client terminal apparatus that requests the recorded content from said server terminal apparatus,
wherein said server terminal apparatus includes:
a content storage unit operable to store broadcasted content as the recorded content;
a first terminal information holding unit which holds first terminal identification information for identifying said server terminal apparatus;
a first password holding unit operable to acquire first password information associated with the first terminal identification information from the broadcast station apparatus and hold the first password information;
a connection permission unit operable to compare password information sent from another terminal apparatus with the first password information held by said first password holding unit, and to permit connection of the other apparatus when the password information and first password information match; and
a first processing unit operable to receive, from the other apparatus permitted to connect by said connection permission unit, a request to transfer the recorded content stored in said content storage unit, and to transfer the recorded content to a transfer destination, and
said client terminal apparatus includes:
a second terminal information holding unit which holds second terminal identification information for identifying said client terminal apparatus;
a second password holding unit operable to acquire second password information associated with the second terminal identification information from the broadcast station apparatus and hold the second password information; and
a second processing unit operable to send a second password held in said second password holding unit to said server terminal apparatus so as to connect to said server terminal apparatus, and after being permitted to connect by said server terminal apparatus, to request the transfer of the recorded content stored in said server terminal apparatus, and to store the transferred recorded content in the storage medium.

14. The content management system according to claim 13, further comprising
the broadcast station apparatus,
wherein said broadcast station apparatus includes:
a table holding unit which holds a terminal group management table including: a terminal identification list that has terminal identification information for identifying a terminal which can be connected to; terminal group identification information which identifies the terminal identification list; and password information corresponding to the terminal group identification information; and
a password issuing unit operable to issue password information in response to a request for acquisition of the password information on the part of said terminal apparatuses, and
wherein said client terminal apparatus and said server terminal apparatus are respectively operable to send the first and second terminal identification information held in said first and second terminal information holding units, along with the request for acquisition of the first and the second password information;
said password issuing unit is operable to refer to the terminal group management table and issue the password information corresponding to the terminal group identification information that identifies the terminal identification list present in the received terminal identification information; and
the password information is different in each terminal group identification information.

15. The content management system according to claim 14,
wherein said broadcast station apparatus further holds group lock locking information which is associated with the terminal group identification information;
said client terminal apparatus further includes
a group lock locking unit operable to acquire, from said broadcast station apparatus, the group lock locking information corresponding to the terminal group identification information that identifies the terminal identification list including the second terminal identification information held by said client terminal apparatus, to hold the group lock locking information, and to set a restriction on copying of the recorded content using the held group lock locking information; and
said group lock locking unit is operable to set the restriction on copying of the recorded content using the group lock locking information after the recorded content has been stored in the storage medium.

16. The content management system according to claim 15,
wherein said client terminal apparatus further includes
a judgment unit operable to judge whether or not the storage medium is a portable storage medium, and
in the case where the storage medium is judged by said judgment unit to be a portable storage medium, said group lock locking unit is operable to set the restriction on copying of the recorded content using the group lock locking information after the recorded content has been stored in the portable storage medium.

17. The content management system according to claim 16,
wherein said broadcast station apparatus further holds group lock unlocking information which is associated with the terminal group identification information; and
said client terminal apparatus further includes
a group lock unlocking unit operable to acquire, from said broadcast station apparatus, the group lock unlocking information corresponding to the terminal group identification information that identifies the terminal identification list including the second terminal identification information held by said client terminal apparatus, to hold the group lock unlocking information, and to release the restriction on copying of the recorded content stored in the portable storage medium using the group lock unlocking information acquired from said broadcast station apparatus.

18. A content management system comprising:
a server terminal apparatus that holds, as recorded content, content broadcasted from a broadcast station apparatus; and
a client terminal apparatus that requests the recorded content from said server terminal apparatus,
wherein said server terminal apparatus includes:
a content storage unit operable to store broadcasted content as the recorded content;
a first terminal information holding unit which holds first terminal information for identifying said server terminal apparatus;
a terminal identification list holding unit operable to acquire a terminal identification list including the first terminal identification information from the broadcast station apparatus, and hold the terminal identification list;
a connection permission unit operable to compare terminal identification information sent from another terminal apparatus with the terminal identification information present in the terminal identification list held by said terminal identification list holding unit, and to permit connection of the other apparatus when the terminal identification information matches; and
a first processing unit operable to receive, from the other apparatus permitted to connect by said connection permission unit, a request to transfer the recorded content stored in said content storage unit, and to transfer the recorded content to a transfer destination, and
said client terminal apparatus includes:
a second terminal information holding unit which holds second terminal identification information for identifying said client terminal apparatus; and
a second processing unit operable to send the second terminal identification information held in said second terminal information holding unit to said server terminal apparatus so as to connect to said server terminal apparatus, and after being permitted to connect by said server terminal apparatus, to request the transfer of the recorded content stored in said server terminal apparatus, and to store the transferred recorded content in the storage medium.

19. The content management system according to claim 18, further comprising
the broadcast station apparatus,
wherein said broadcast station apparatus includes:
a table holding unit which holds a terminal group management table including: a terminal identification list that has terminal identification information for identifying a terminal which can be connected to; and a terminal group ID which identifies the terminal identification list; and
a terminal identification list issuing unit operable to issue the terminal identification list corresponding to said server terminal apparatus in response to a request for acquisition of the terminal identification list on the part of said server terminal apparatus, and
wherein said server terminal apparatus is operable to send the first terminal identification information held by said server terminal apparatus to said broadcast station apparatus along with the request for acquisition of the terminal identification list; and
said terminal identification list issuing unit of said broadcast station apparatus is operable to refer to the terminal group management table and issue the terminal identification list including the first terminal identification information to said server terminal apparatus.

20. The content management system according to claim 19,
wherein said broadcast station apparatus further holds group lock locking information which is associated with the terminal group identification information;
said client terminal apparatus further includes
a group lock locking unit operable to acquire, from said broadcast station apparatus, the group lock locking information corresponding to the terminal group identification information that identifies the terminal identification list including the second terminal identification information held by said client terminal apparatus, to hold the group lock locking information, and to set a restriction on copying of the recorded content using the held group lock locking information; and
said group lock locking unit is operable to set the restriction on copying of the recorded content using the group lock locking information after the recorded content has been stored in the storage medium.

21. The content management system according to claim 20,
wherein said client terminal apparatus further includes
a judgment unit operable to judge whether or not the storage medium is a portable storage medium, and
in the case where the storage medium is judged by said judgment unit to be a portable storage medium, said group lock locking unit is operable to set the restriction on copying of the recorded content using the group lock locking information after the recorded content has been stored in the portable storage medium.

22. The content management system according to claim 21,
wherein said broadcast station apparatus further holds group lock unlocking information which is associated with the terminal group identification information; and
said client terminal apparatus further includes
a group lock unlocking unit operable to acquire, from said broadcast station apparatus, the group lock unlocking information corresponding to the terminal group identification information that identifies the terminal identification list including the second terminal identification information held by said client terminal apparatus, to hold the group lock unlocking information, and to release the restriction on copying of the recorded content stored in the portable storage medium using the group lock unlocking information acquired from said broadcast station apparatus.

23. A client terminal apparatus which makes a request for recorded content to a server terminal apparatus that holds, as the recorded content, content broadcasted from a broadcast station apparatus, said client terminal apparatus comprising:
a terminal information holding unit which holds terminal identification information for identifying said client terminal apparatus;
an inquiry unit operable to inquire with the broadcast station apparatus as to whether or not transfer of the recorded content stored in a content storage unit of said server terminal apparatus is permitted; and
so a processing unit operable to request said server terminal apparatus to transfer the recorded content in the case where the transfer is permitted by the broadcast station apparatus, and to store the transferred recorded content in a storage medium.

24. A server terminal apparatus that holds, as recorded content, content broadcasted from a broadcast station apparatus, said server terminal apparatus comprising:
a content storage unit operable to store content broadcasted over a predetermined channel in association with an identifier of the predetermined channel as the recorded content;
an inquiry unit operable to receive a request to transfer the recorded content stored in said content storage unit, and to inquire with the broadcast station apparatus as to whether or not transfer of the recorded content is permitted; and
a processing unit operable to transfer the recorded content to a transfer destination in the case where the transfer is permitted by the broadcast station apparatus.

25. A server terminal apparatus that holds, as recorded content, content broadcasted from a broadcast station apparatus, said server terminal apparatus comprising:
a content storage unit operable to store broadcasted content as the recorded content;
a terminal information holding unit which holds terminal information for identifying said server terminal apparatus;
a password holding unit operable to acquire password information associated with the terminal identification information from the broadcast station apparatus and hold the password information;
a connection permission unit operable to compare password information sent from another terminal apparatus with the password information held by said password holding unit, and to permit connection of the other apparatus when the password information matches; and
a processing unit operable to receive, from the other apparatus permitted to connect by said connection permission unit, a request to transfer the recorded content stored in said content storage unit, and to transfer the recorded content to a transfer destination.

26. A client terminal apparatus which makes a request for recorded content to a server terminal apparatus that holds, as the recorded content, content broadcasted from a broadcast station apparatus, said client terminal apparatus comprising:
a terminal information holding unit which holds second terminal identification information for identifying said client terminal apparatus;
a password holding unit operable to acquire password information associated with the terminal identification information from the broadcast station apparatus and hold the password information; and
a processing unit operable to send a password held in said password holding unit to said server terminal apparatus so as to connect to said server terminal apparatus, and after being permitted to connect by said server terminal apparatus, to request the transfer of the recorded content stored in said server terminal apparatus, and to store the transferred recorded content in the storage medium.

27. A server terminal apparatus that holds, as recorded content, content broadcasted from a broadcast station apparatus, said server terminal apparatus comprising:
a content storage unit operable to store broadcasted content as the recorded content;
a terminal information holding unit which holds terminal information for identifying said server terminal apparatus;
a terminal identification list holding unit operable to acquire a terminal identification list including the terminal identification information from the broadcast station apparatus, and hold the terminal identification list;
a connection permission unit operable to compare terminal identification information sent from another terminal apparatus with the terminal identification information present in the terminal identification list held by said terminal identification list holding unit, and to permit connection of the other apparatus when the terminal identification lists match; and
a processing unit operable to receive, from the other apparatus permitted to connect by said connection permission unit, a request to transfer the recorded content stored in said content storage unit, and to transfer the recorded content to a transfer destination.

28. A client terminal apparatus which makes a request for recorded content to a server terminal apparatus that holds, as the recorded content, content broadcasted from a broadcast station apparatus, said client terminal apparatus comprising:
a terminal information holding unit which holds terminal identification information for identifying said client terminal apparatus; and
a processing unit operable to send the terminal identification information held in said terminal information holding unit to said server terminal apparatus so as to connect to said server terminal apparatus, and after being permitted to connect by said server terminal apparatus, to request the transfer of the recorded content stored in said server terminal apparatus, and to store the transferred recorded content in the storage medium.

29. A content management method for a system including a server terminal apparatus that holds, as recorded content, content broadcasted from a broadcast station apparatus, and a client terminal apparatus that requests the recorded content from the server terminal apparatus, said method comprising:
in the server terminal apparatus:
a first processing step of receiving a request to transfer the recorded content stored in a content storage unit, and transferring the recorded content, and
in the client terminal apparatus:
an inquiry step of inquiring with the broadcast station apparatus as to whether or not transfer of the recorded content stored in the content storage unit of the server terminal apparatus is permitted; and
a second processing step of requesting the server terminal apparatus to transfer the recorded content in the case where the transfer is permitted by the broadcast station apparatus, and storing the transferred recorded content in a storage medium.

30. A content management method for a system including a server terminal apparatus that holds, as recorded content, content broadcasted from a broadcast station apparatus, and a client terminal apparatus that requests the recorded content from the server terminal apparatus, said method comprising:
in the server terminal apparatus:
an inquiry step of receiving a request to transfer the recorded content stored in a content storage unit, and inquiring with the broadcast station apparatus as to whether or not transfer of the recorded content is permitted; and
a first processing step of transferring the recorded content to a transfer destination in the case where the transfer is permitted by the broadcast station apparatus, and
in the client terminal apparatus:
a second processing step of requesting the server terminal apparatus to transfer the recorded content and storing the transferred recorded content in a storage medium.

31. A content management method for a system including a server terminal apparatus that holds, as recorded content, content broadcasted from a broadcast station apparatus, and a client terminal apparatus that requests the recorded content from the server terminal apparatus, said method comprising:
in the server terminal apparatus:
a first password holding step of acquiring first password information associated with first terminal identification information for specifying the server terminal apparatus from the broadcast station apparatus, and holding the first password information;
a connection permission step of comparing password information sent from another terminal apparatus with the first password information, and permitting connection of the other apparatus when the password information and first password information match; and
a first processing step of receiving, from the other apparatus permitted to connect in said connection permission step, a request to transfer the recorded content stored in a content storage unit, and transferring the recorded content to a transfer destination, and
in the client terminal apparatus:
a second password holding step of acquiring second password information associated with the second terminal identification information for specifying the client terminal apparatus from the broadcast station apparatus, and holding the second password information; and
a second processing step of sending the second password to the server terminal apparatus so as to connect to the server terminal apparatus, and after being permitted to connect by the server terminal apparatus, requesting the transfer of the recorded content stored in the server terminal apparatus, and storing the transferred recorded content in a storage medium.

32. A content management method for a system including a server terminal apparatus that holds, as recorded content, content broadcasted from a broadcast station apparatus, and a client terminal apparatus that requests the recorded content from the server terminal apparatus, said method comprising:
in the server terminal apparatus:
a terminal identification list holding step of acquiring a terminal identification list including the first terminal identification information for specifying the server terminal apparatus from the broadcast station apparatus, and holding the terminal identification list;
a connection permission step of comparing terminal identification information sent from another terminal apparatus with the terminal identification information present in the terminal identification list, and permitting connection of the other apparatus when the terminal identification information matches; and
a first processing step of receiving, from the other apparatus permitted to connect in said connection permission step, a request to transfer the recorded content stored in a content storage unit, and transferring the recorded content to a transfer destination, and
in the client terminal apparatus:
a second processing step of sending second terminal identification information for identifying the client terminal apparatus to the server terminal apparatus so as to connect to the server terminal apparatus, and after being permitted to connect by the server terminal apparatus, requesting the transfer of the recorded content stored in the server terminal apparatus, and storing the transferred recorded content in a storage medium.

33. A program for a client terminal apparatus which makes a request for recorded content to a server terminal apparatus that holds, as the recorded content, content broadcasted from a broadcast station apparatus, said program causing a computer to execute:
an inquiry step of inquiring with the broadcast station apparatus as to whether or not transfer of the recorded content stored in the server terminal apparatus is permitted; and
a processing step of requesting the server terminal apparatus to transfer the recorded content in the case where the transfer is permitted by the broadcast station apparatus, and storing the transferred recorded content in a storage medium.

34. A program for a server terminal apparatus that holds, as recorded content, content broadcasted from a broadcast station apparatus, said program causing a computer to execute:
an inquiry step of receiving a request to transfer the recorded content stored in a content storage unit, and inquiring with the broadcast station apparatus as to whether or not transfer of the recorded content is permitted; and
a processing step of transferring the recorded content to a transfer destination in the case where the transfer is permitted by the broadcast station apparatus.
